(19) United States
(12) Patent Application Publication
(10) Pub. No.: US 2014/0233726 A1
(43) Pub. Date: Aug. 21, 2014

(54) DECRYPTION METHOD, RECORDING MEDIUM STORING DECRYPTION PROGRAM, DECRYPTION DEVICE, KEY GENERATION METHOD, AND RECORDING MEDIUM STORING KEY GENERATION PROGRAM

(71) Applicant: FUJITSU LIMITED, Kawasaki-shi (JP)

(72) Inventors: Jun YAJIMA, Kawasaki (JP); MASAYA YASUDA, Kawasaki (JP); Takeshi SHIMOYAMA, Shinagawa (JP); Jun KOGURE, Kawasaki (JP)

(73) Assignee: FUJITSU LIMITED, Kawasaki-shi (JP)

(21) Appl. No.: 14/081,231

(22) Filed: Nov. 15, 2013

(30) Foreign Application Priority Data
Nov. 20, 2012 (JP) 2012-254698

(51) Int. Cl. H04L 9/00

(52) U.S. Cl. CPC H04L 9/008; H04L 2209/24
USPC 380/28

(57) ABSTRACT

A decryption method includes receiving an input of an n-dimensional vector whose elements other than a first element are all zero, or of the first element. The vector is a ciphertext obtained by encrypting a plaintext being an integer not less than 0 and less than s with a public key, or by performing an operation on a plurality of ciphertexts without decrypting them. The public key is associated with an n×n invertible matrix V defined as a secret key of homomorphic cryptography by using n integers, and is a matrix B being an Hermite normal form of V. The decryption method also includes: acquiring an element w which is coprime to s and which is one of elements of a matrix W=dV⁻¹ defined by a determinant d of B and V⁻¹; acquiring w⁻¹ modulo s; calculating b=[c×w]_{d}×w⁻¹ mod s; and outputting b as a plaintext.

### CROSS-REFERENCE TO RELATED APPLICATION

This application is based upon and claims the benefit of priority of the prior Japanese Patent Application No. 2012-254698, filed on Nov. 20, 2012, the entire contents of which are incorporated herein by reference.

### FIELD

The embodiments discussed herein are related to homomorphic cryptography.

### BACKGROUND

Cryptography may be categorized into either symmetric-key cryptography or public-key cryptography. In the symmetric-key cryptography, an encryption key is identical to a decryption key. On the other hand, in the public-key cryptography, a pair of different keys are used in encryption and decryption.

In many types of public-key cryptography, a public key used in encryption is made public in advance, and a secret key (i.e., private key) used in decryption is held as secret information. Concretely, for example, a sender encrypts a plaintext using the public key of a receiver, and sends a ciphertext. The receiver decrypts the ciphertext using the secret key of the receiver, and thereby obtains the plaintext.

Homomorphic cryptography, which is also called a homomorphic encryption scheme, is a kind of the public-key cryptography that enables data processing in which data is kept in an encrypted form. For example, let m₁ and m₂ be plaintexts, and let E be an encryption function. The encryption function E which satisfies the following equation (1) for any two plaintexts m₁ and m₂ is homomorphic with respect to addition. On the other hand, the encryption function E which satisfies the following equation (2) for any two plaintexts m₁ and m₂ is homomorphic with respect to multiplication.

E(m₁)+E(m₂)=E(m₁+m₂) (1)

E(m₁)×E(m₂)=E(m₁×m₂) (2)

In the homomorphic cryptography, performing an addition and/or a multiplication of ciphertexts makes it possible to obtain a ciphertext for an operation result of an addition and/or a multiplication of plaintexts without decrypting the ciphertexts. This feature of the homomorphic cryptography is effective in the fields of, for example, electronic voting, electronic money, etc.

For example, the additive E1 Gama1 cryptography and the Paillier cryptography are homomorphic with respect to addition, and satisfy equation (1). Furthermore, the RSA cryptography (Rivest-Shamir-Adleman cryptography) is homomorphic with respect to multiplication, and satisfies equation (2).

Recently, a kind of cryptography which is homomorphic with respect to both addition and multiplication (i.e., a kind of cryptography which satisfies both equations (1) and (2)) is proposed by Gentry. Not only theoretical proposals but also proposals for concrete implementation are presented for cryptography homomorphic with respect to both addition and multiplication.

For example, a key generation device proposed with respect to homomorphic cryptography includes an arbitrary value generation unit and a cryptographic key generation unit. The arbitrary value generation unit generates n arbitrary values λ₁ (i=0, . . . , n−1, where n is a positive integer) whose absolute values are not less than a prescribed value. The cryptographic key generation unit generates, as a cryptographic key of the homomorphic cryptography, an n×n matrix defined in relation to an n×n circulant matrix rot (v) where n elements corresponding to the results of the discrete Fourier transform on the n arbitrary values λᵢ (i=0, . . . , n−1) are vᵢ (i=0, . . . , n−1).

From the viewpoint of the type of operation that enables data processing in which data is kept in an encrypted form, the encryption scheme in the homomorphic cryptography may be classified into the following three types.
HE (homomorphic encryption) scheme
SHE (somewhat homomorphic encryption) scheme
FHE (fully homomorphic encryption) scheme

Examples of the HE scheme include the above-mentioned additive E1 Gama1 cryptography, the Paillier cryptography, etc. In the cryptography of the HE scheme, only a single type of operation (for example, addition or multiplication) enables data processing in which data is processed while being kept in an encrypted form. In the cryptography of the HE scheme, it is feasible to perform the processes such as key generation, encryption, decryption, etc. at a high speed.

In the cryptography of the SHE scheme, it is possible to perform additions and N times of multiplication while keeping data in an encrypted form. In the cryptography of the SHE scheme, it is feasible to perform the processes such as key generation, encryption, decryption, etc. at a somewhat high speed.

In the cryptography of the FHE scheme, it is possible to perform any type of operations on data while keeping the data in an encrypted form. However, the processes such as key generation, encryption, decryption, etc. in the cryptography of the FHE scheme are performed very slowly.

Therefore, to perform a complicated process at a high speed, the SHE scheme is favorable. Furthermore, not only the SHE scheme in which the set {0, 1} is the plaintext space, but also the SHE scheme in which the set {0, 1, . . . , s−1} is the plaintext space (i.e., the SHE scheme with the extended plaintext space) has been proposed.

For example, some documents as listed below are well known.
Japanese Laid-open Patent Publication No. 2011-145512
Craig Gentry, “Fully Homomorphic Encryption Using Ideal Lattices”, STOC (Symposium on Theory of Computing) 2009, pp. 169-178, 2009.
Craig Gentry and Shai Halevi, “Implementing Gentry's Fully-Homomorphic Encryption Scheme”, EUROCRYPT 2011, LNCS (Lecture Notes in Computer Science) 6632, pp. 129-148, 2011.
Masaya Yasuda, Jun Yajima, Takeshi Shimoyama, and Jun Kogure, “Secret totalization of purchase histories of companies in cloud” SCIS 2012 (Symposium on Cryptography and Information Security), 3D2-5.

### SUMMARY

According to an aspect of the embodiments, a decryption method executed by a computer is provided.

The decryption method includes receiving, by the computer, an input of an n-dimensional vector \vec{c}=(c, 0, . . . ,0) whose elements other than a first element are all zero, or an input of a value c that is the first element of the vector \vec{c}. The vector \vec{c} is a ciphertext obtained by encrypting a plaintext being an integer not less than 0 and less than s with a public key, or by performing a certain operation on a plurality of ciphertexts without decrypting the plurality of ciphertexts. The public key is associated with an n×n invertible matrix

$$V = [ \begin{matrix}{v}_{0} & {v}_{1} & {v}_{2} & … & {v}_{n - 1} \\ - {v}_{n - 1} & {v}_{0} & {v}_{1} & … & {v}_{n - 2} \\ - {v}_{n - 2} & - {v}_{n - 1} & {v}_{0} & … & {v}_{n - 3} \\ ⋮ & ⋮ & ⋮ & ⋱ & ⋮ \\ - {v}_{1} & - {v}_{2} & - {v}_{3} & … & {v}_{0}\end{matrix} ]$$

defined as a secret key of homomorphic cryptography by using n integers v₀, . . . , vₙ₋₁. The public key is a matrix B being an Hermite normal form of the matrix V. Each of the plurality of ciphertexts is obtained by encrypting each of a plurality of plaintexts being an integer not less than 0 and less than s with the matrix B.

The decryption method includes acquiring, by the computer, an element w which is coprime to s and which is one of elements of a matrix W=dV⁻¹ defined by a determinant d of the matrix B and an inverse matrix V⁻¹ of the matrix V. The decryption method includes acquiring, by the computer, an inverse w⁻¹ of w modulo s. The decryption method includes calculating, by the computer, a value b=[c×w]_{d}×w⁻¹ mod s using a value [c×w]_{d} to which c×w mod d is regulated to be included in an interval [−d/2, d/2). The decryption method includes outputting, from the computer, the calculated value b as a plaintext which corresponds to the input vector \vec{c} or to the input value c.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a flowchart of a decryption method according to the first embodiment;

FIG. 2 illustrates the hardware configuration of a computer;

FIG. 3 is a block diagram of a decryption device according to the third comparative example;

FIG. 4 is a flowchart (No. 1) of a decryption method according to the third comparative example;

FIG. 5 is a flowchart (No. 2) of the decryption method according to the third comparative example;

FIG. 6 is a flowchart (No. 3) of the decryption method according to the third comparative example;

FIG. 7 is a block diagram of an information processing device according to the second embodiment;

FIG. 8 is a flowchart (No. 1) of the process performed by the information processing device according to the second embodiment;

FIG. 9 is a flowchart (No. 2) of the process performed by the information processing device according to the second embodiment;

FIG. 10 is a flowchart (No. 3) of the process performed by the information processing device according to the second embodiment;

FIG. 11 is a flowchart of a decrypting process common to the second and third embodiments; and

FIG. 12 is a block diagram of a decryption device according to the third embodiment.

### DESCRIPTION OF EMBODIMENTS

In the homomorphic cryptography with an extended plaintext space that is constituted by integers not less than 0 and not more than (s−1), the multiplication of a vector and a matrix is performed twice in decryption. Therefore, when there are a large number of elements in the vector, the computational complexity of the decryption is also large, thereby taking a long time to perform the decryption.

It is an object in an aspect of the following embodiments to perform the decryption in a higher speed in the homomorphic cryptography with an extended plaintext space. In the decryption methods according to the following embodiments, the decryption is performed at a higher speed in the homomorphic cryptography with an extended plaintext space.

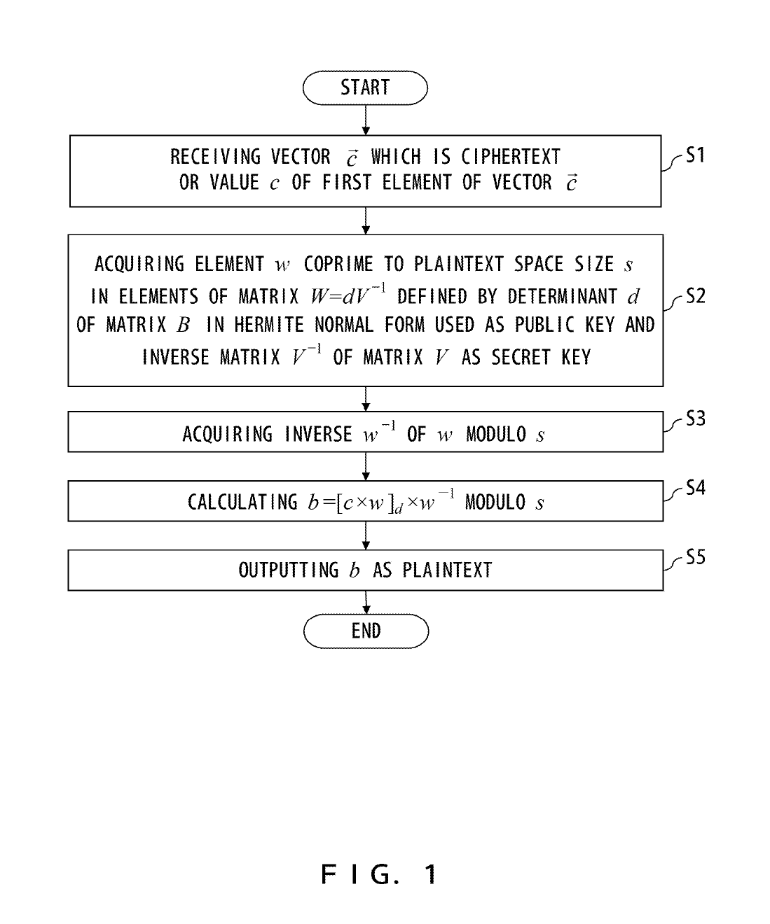

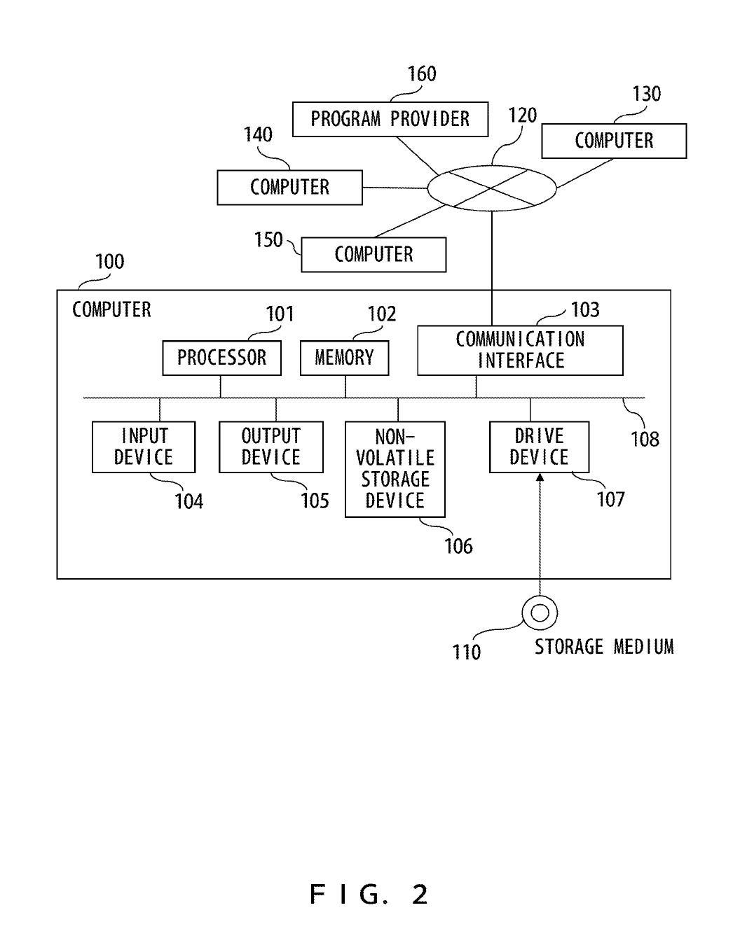

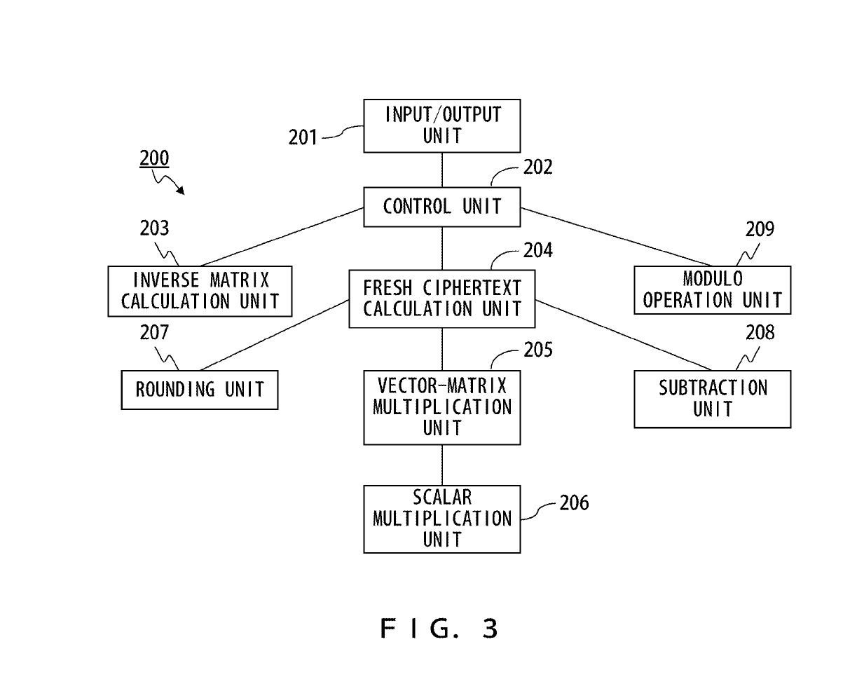

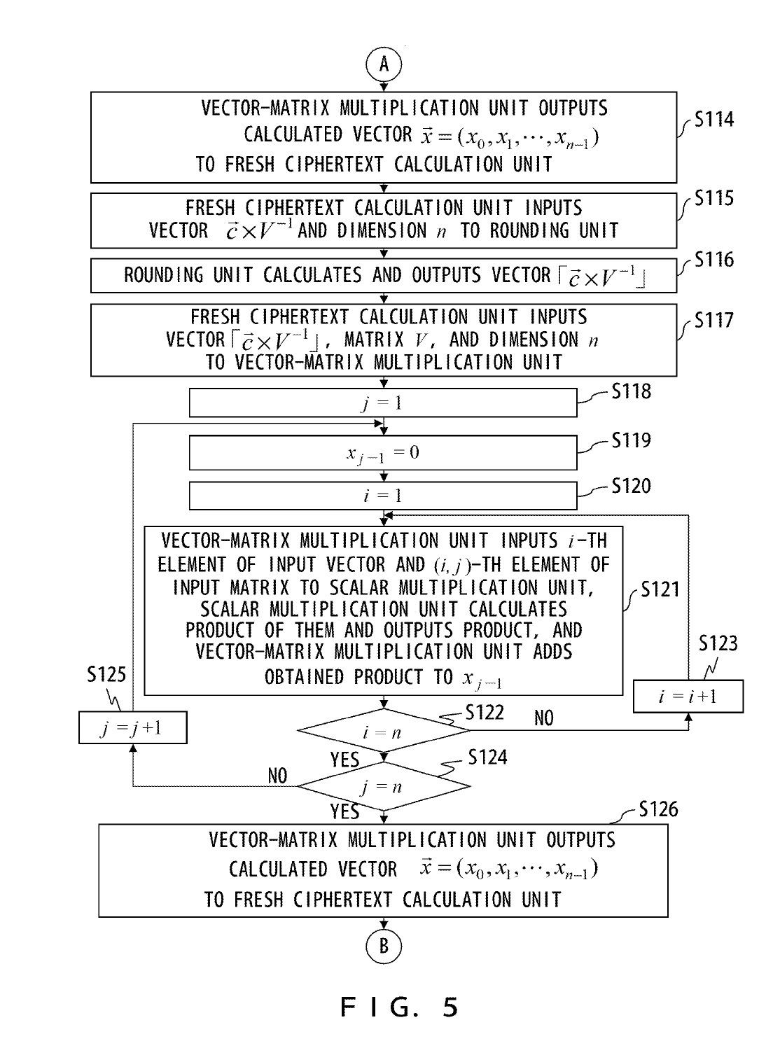

The embodiments are described below in detail with reference to the attached drawings. Concretely, the first embodiment is described with reference to FIGS. 1 and 2. Then, three comparative examples are described. Among them, the third comparative example is described with reference to FIGS. 3 through 6. After describing the three comparative examples, the merits of the first embodiment in comparison with the comparative examples and the mathematical background of the first embodiment are also described.

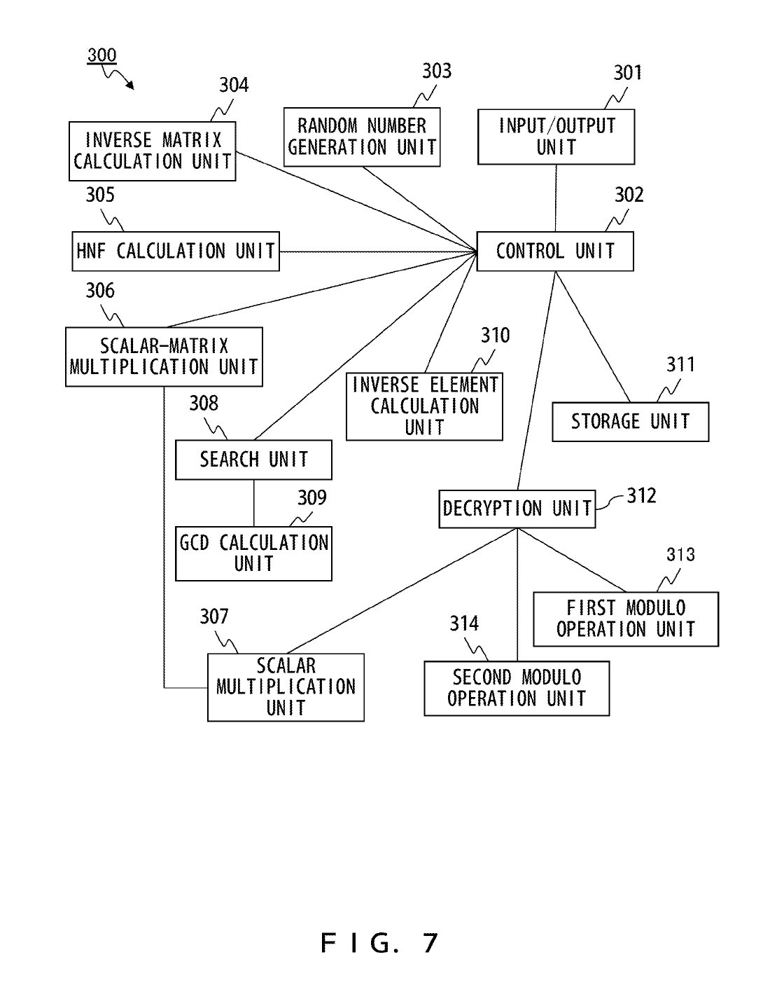

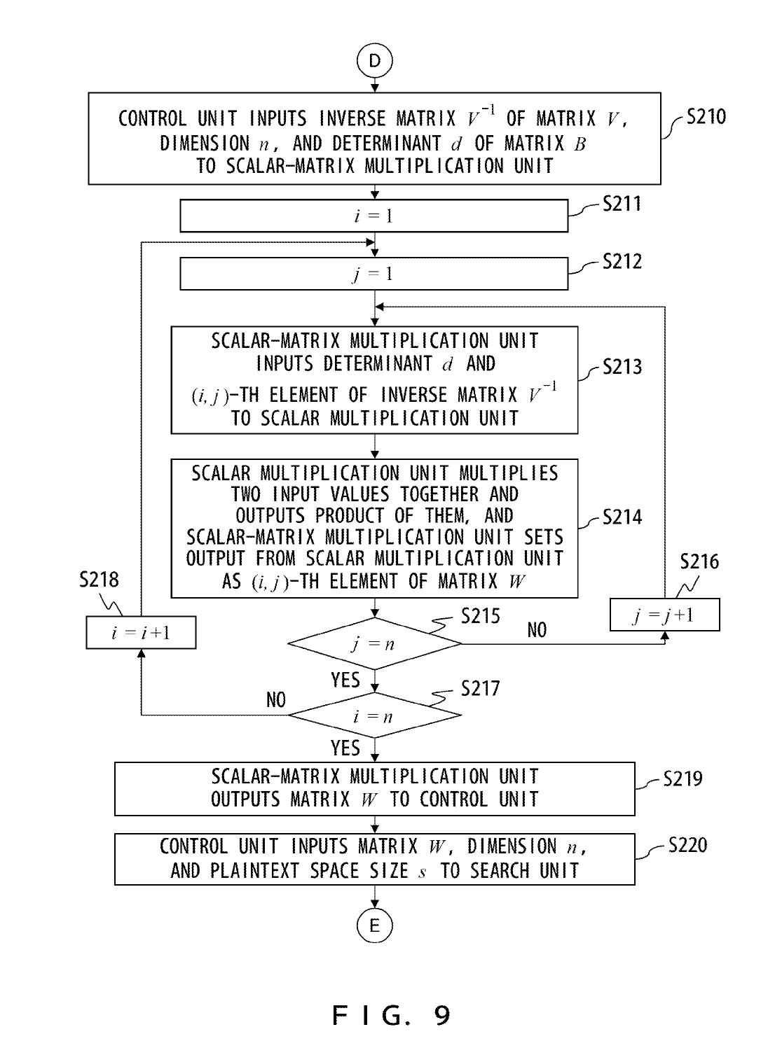

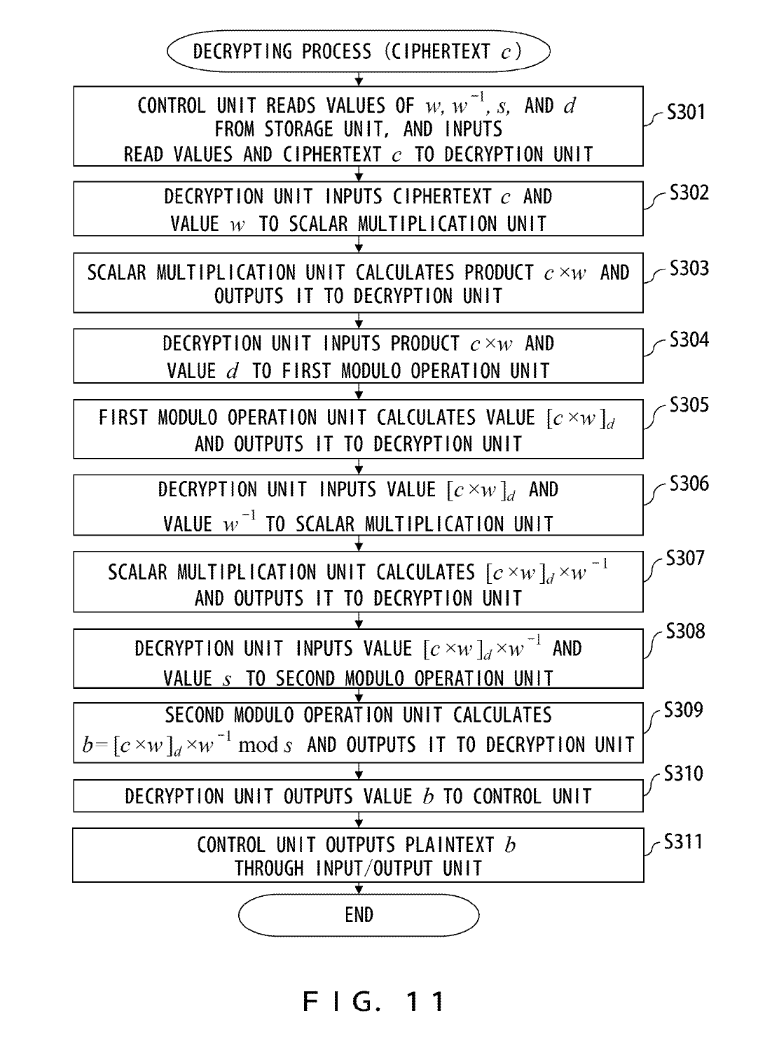

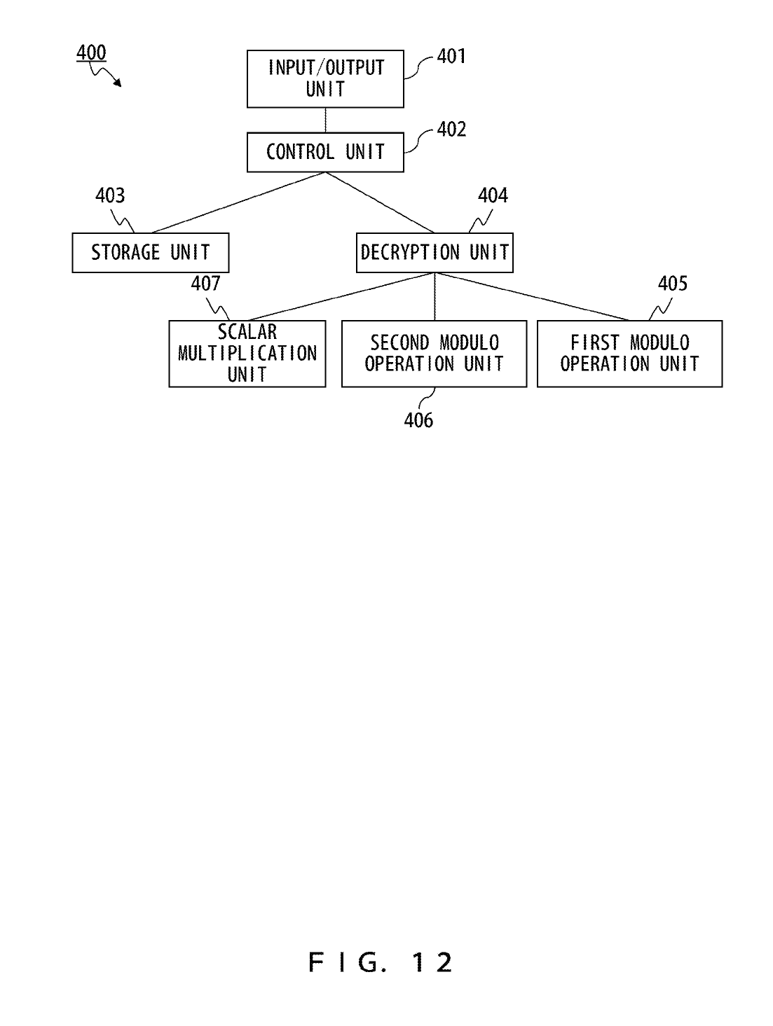

Then, the second embodiment is described with reference to FIGS. 7 through 11. FIG. 11 illustrates the process common to the second and third embodiments. The third embodiment is described with reference to FIGS. 11 and 12. Finally, other modifications are described.

FIG. 1 is a flowchart of a decryption method according to the first embodiment. In step S1, a computer which executes the decryption method illustrated in FIG. 1 receives one of the inputs below.
An n-dimensional vector \vec{c}=(c, 0, . . . ,0) whose elements other than the first element are all zero.
A value c which is the first element of the vector \vec{c}.

Since all elements other than the first element are zero in the vector \vec{c}, the vector \vec{c} may be regarded as the scalar c when the dimension n of the vector \vec{c} is known. Therefore, the computer may receive the input of the vector \vec{c}, or the input of the value c in step S1.

The computer may receive the vector \vec{c} or the value c through an input device (for example, a keyboard, a pointing device, a camera, etc.) of the computer. The computer may receive the vector \vec{c} or the value c from another device over a network.

The vector \vec{c} may specifically be a ciphertext corresponding to a plaintext which is an integer not less than 0 and less than s (where s is a predetermined integer not less than 2). That is, the computer may execute the decryption method illustrated in FIG. 1 to decrypt a ciphertext obtained by encrypting a single certain plaintext.

Otherwise, the vector \vec{c} may be a single ciphertext obtained as a result of performing a certain operation on a plurality of ciphertexts without decrypting the plurality of ciphertexts. Each of the plurality of ciphertexts is obtained by encrypting each of a plurality of plaintexts. Each of the plurality of plaintexts is an integer not less than 0 and less than s. The certain operation may be, for example, an operation to be performed for secret totalization. That is, the computer may perform the decryption method illustrated in FIG. 1 in order to decrypt the result of the totalization that has been performed while keeping each piece of data in the encrypted form.

The encryption scheme according to the first embodiment is the SHE scheme. Therefore, the above-mentioned “certain operation” is concretely one of the following operations (where N indicates a predetermined constant not less than 1).
an operation of performing addition once or more times
an operation of performing multiplication not less than once and not more than N times
an operation of performing addition once or more times and performing multiplication not less than once and not more than N times

In the first embodiment, the n×n invertible matrix V defined by using n integers v₀, . . . , vₙ₋₁ as indicated in equation (3) is used as a secret key (i.e., private key) of the homomorphic cryptography.

$$V = [ \begin{matrix}{v}_{0} & {v}_{1} & {v}_{2} & … & {v}_{n - 1} \\ - {v}_{n - 1} & {v}_{0} & {v}_{1} & … & {v}_{n - 2} \\ - {v}_{n - 2} & - {v}_{n - 1} & {v}_{0} & … & {v}_{n - 3} \\ ⋮ & ⋮ & ⋮ & ⋱ & ⋮ \\ - {v}_{1} & - {v}_{2} & - {v}_{3} & … & {v}_{0}\end{matrix} ] \qquad ( 3 )$$

A matrix B which is the Hermite normal form (HNF) of the matrix V is used as a public key that is associated with the secret key V. The Hermite normal form is a lower triangular matrix or an upper triangular matrix obtained by applying elementary row operations defined on integers to an integer matrix. It is well known that it is possible to efficiently calculate the Hermite normal form (for example, refer to P. Domich, R. Kannan and L. Trotter, “Hermite normal form computation using modulo determinant arithmetic”, Math. Oper. Research 12:50-59, 1987, etc.).

Since the above-mentioned public key B is used, the vector \vec{c} is, more specifically, one of the following ciphertexts.
A ciphertext obtained by encrypting, with the matrix B, a plaintext which is an integer not less than 0 and less than s.
A single ciphertext obtained by performing a certain operation on a plurality of ciphertexts without decrypting the plurality of ciphertexts, where each of the plurality of ciphertexts is obtained by encrypting, with the matrix B, each of a plurality of plaintexts and each of the plurality of plaintexts is an integer not less than 0 and less than s.

Note that s is a predetermined integer not less than 2 as described above and that s defines the plaintext space. That is, the plaintext space is the set {0, 1, . . . , s−1}.

Then, in step S2 after step S1 described above, the computer acquires an element w coprime to the plaintext space size s in the elements of the matrix W=dV⁻¹ defined by the determinant d of the matrix B and the inverse matrix V⁻¹ of the matrix V. By definition, the matrix W is an n×n square matrix.

For example, in step S2, the computer may acquire the determinant d from the matrix B, calculate the inverse matrix V⁻¹ from the matrix V, and calculate the matrix W from the determinant d and the inverse matrix V. As described later in detail, since the matrix B has a specific form, the determinant d of the matrix B is equal to the (1,1)-th element of the matrix B. Therefore, the computer is able to easily acquire the determinant d from the matrix B. Then, the computer may search, for an element coprime to the plaintext space size s, the n×n elements of the matrix W calculated as described above.

Although the proof is omitted, the matrix W has regularity as understood from the numerical examples described later. This is because the matrix V has the regularity like equation (3).

Concretely, the value of each element in the second row through the n-th row of the matrix W is either equal to the value of an element of one of the columns in the first row of the matrix W, or equal to the product of −1 and the value of an element of one of the columns in the first row of the matrix W. Therefore, it is not necessary for the computer to check all of n×n elements of the matrix W.

It is sufficient for the computer to search the n elements in any row of the matrix W for an element coprime to the predetermined integer s. Obviously, the computer may search the n elements in any column of the matrix W for an element coprime to the predetermined integer s.

Therefore, it is not always necessary for the computer to calculate the matrix W from the determinant d and the inverse matrix V⁻¹ as described above. That is, it is sufficient for the computer to calculate at least n elements in one row of the matrix W, and to search the n calculated elements for an element coprime to the predetermined constant s. Alternatively, it is sufficient for the computer to calculate at least n elements in one column of the matrix W, and to search the n calculated elements for an element coprime to the predetermined constant s.

In any case, the computer may acquire, as the element w, the element found as a result of the search. For example, when the computer, which performs the process in FIG. 1, is a key generation device which generates the secret key V and the public key B, the computer may acquire the element w by the above-mentioned calculation and search.

Furthermore, also when the computer, which performs the process in FIG. 1, is not the key generation device, the computer may acquire the element w by the search. For example, the computer may receive the secret key V from the key generation device through a secure encrypted communication path, calculate the matrix W based on the received secret key V, and perform the above-mentioned search. Thus, the computer is able to acquire the element w as a result of the search.

As another example, in step S2, the computer may acquire the element w coprime to the predetermined integer s by receiving the element w from another device. For example, the computer may be a device other than the key generation device, which generates the secret key V and the public key B. In this case, the computer may be connected to the key generation device through a secure encrypted communication path, and may receive the element w from the key generation device through the secure encrypted communication path.

FIG. 1 corresponds to one round of decryption (i.e., FIG. 1 corresponds to decryption for one ciphertext). Obviously, the computer, which performs the process in FIG. 1, may perform decryption each time a new ciphertext vector \vec{c} (or the value c of its first element) is received.

In this case, the computer may acquire the element w by the calculation and search in step S2 in performing decryption for the first time, and may store the acquired element w in a storage device. Then, the computer is able to acquire the element w only by reading the element w from the storage device in step S2 in performing decryption for the second time or later.

Similarly, in step S2 in performing decryption for the first time, the computer may acquire the element w by receiving it from another device, and may store the acquired element w in the storage device. Then, the computer is able to acquire the element w only by reading the element w from the storage device in step S2 in performing decryption for the second time or later.

Obviously, the computer may acquire the element w by the calculation and search in advance before performing decryption for the first time, and may store the acquired element w in the storage device. Similarly, before performing decryption for the first time, the computer may acquire the element w by receiving it from another device in advance, and may store the acquired element w in the storage device. Then, the computer is able to acquire the element w only by reading the element w from the storage device in step S2 in performing decryption for the first time.

In any case, the computer acquires the element w coprime to the predetermined integer s in step S2. Then, the computer acquires the inverse w⁻¹ of w modulo s in step S3.

For example, in step S3, the computer may calculate the inverse w⁻¹ from the element w acquired in step S2. For example, the computer may acquire the inverse w⁻¹ by searching a set of integers.

As another example, in step S3, the computer may acquire the inverse w⁻¹ by receiving the inverse w⁻¹ from another device (for example, the key generation device).

In step S3 in performing decryption for the first time, the computer may calculate or receive the inverse w⁻¹, and may store the calculated or received inverse w⁻¹ in the storage device. Then, in step S3 in performing decryption for the second time or later, the computer is able to acquire the inverse w⁻¹ only by reading the inverse w⁻¹ from the storage device.

Obviously, before performing decryption for the first time, the computer may acquire the inverse w⁻¹ by the calculation or reception in advance, and may store the acquired inverse w⁻¹ in the storage device. Then, the computer is able to acquire the inverse w⁻¹ only by reading the inverse w⁻¹ from the storage device in step S3 in performing decryption for the first time.

In any case, the computer acquires the inverse w⁻¹ in step S3. Depending on the methods of acquiring the element w and acquiring the inverse w⁻¹, the execution order of steps S2 and S3 may be inverted.

Furthermore, the value of the plaintext space size s may be arbitrarily determined, but it is preferable that the plaintext space size s is a prime number or a power of two for the following reason.

When the plaintext space size s is a prime number, any integer not less than 2 is coprime to the plaintext space size s unless the integer is a multiple of the plaintext space size s. Therefore, when the plaintext space size s is a prime number, the process of searching the elements of the matrix W for an element coprime to the plaintext space size s is a light-load process of searching for an element which is not a multiple of the plaintext space size s.

When the plaintext space size s is a power of two, any odd number is coprime to the plaintext space size s. Therefore, when the plaintext space size s is a power of two, the process of searching the elements of the matrix W for an element coprime to the plaintext space size s is a very light-load process of searching for an element which is an odd number.

As described above, for the effect of reducing the load of the process, it is preferable that the plaintext space size s is a prime number or a power of two. However, it is obvious that a value which is not a prime number or a power of two may be specified as the plaintext space size s.

Next, in step S4, the computer calculates the value b indicated in equation (4).

b=[c×w]_{d}×w⁻¹ mod s (4)

The notation “[c×w]_{d}” in equation (4) indicates a value obtained by regulating (i.e., adjusting) (c×w mod d) so that the obtained value is included in the interval [−d/2, d/2). In other words, the value (c×w mod d) is mapped to the value [c×w]_{d} included in the interval [−d/2, d/2). The notation “[−d/2, d/2)” indicates the interval not less than −d/2 and less than d/2. That is, “[z]_{d}” is defined as in equation (5) for any integer z.

$${[ z ]}_{d} = \{ \begin{matrix}z mod d & ( 0 \leq z mod d < \frac{d}{2} ) \\ ( z mod d ) - d & ( \frac{d}{2} \leq z mod d < d )\end{matrix} \qquad ( 5 )$$

To be more specific, the process in step S4 may be the process including the following operations.
a multiplication of the value c and the value w
a modulo operation with modulus d
a multiplication of the value [c×w]_{d} and the inverse w⁻¹
a modulo operation with modulus s

As another example, the process in step S4 may be the process including the following operations.
a Montgomery modular multiplication with modulus d
a Montgomery modular multiplication with modulus s

Finally, in step S5, the computer outputs the value b calculated in step S4 as a plaintext corresponding to the input vector \vec{c} or the input value c. The output in step S5 may specifically be any of the following processes.
the process of writing the value b to a non-volatile storage device of the computer
the process of displaying the value b to an output device such as a display
the process of transmitting the value b to another device
the process of storing the value b in a storage area (for example, a storage area of the main memory) assigned to a program module for performing a process using the value b

When the plaintext b is obtained by decrypting a single ciphertext which has been obtained as a result of performing a certain operation on a plurality of ciphertexts, there may be a case in which it is not necessary to keep the obtained plaintext b secret. In this case, the computer may transmit the plaintext b to another device through a non-encrypted network. Obviously, the computer may output the plaintext b to another device while keeping the plaintext b in a secret state, by transmitting the plaintext b to another device through a secure encrypted communication path.

By the definition in equation (4), the value b is an integer not less than 0 and not more than (s−1). That is, the value b is included in the plaintext space. A detailed explanation will be given later to explain that the value b obtained as described above is not only included in the plaintext space, but also actually the plaintext corresponding to the ciphertext vector \vec{c}.

The computer, which performs the process in FIG. 1, may be concretely a computer 100 in FIG. 2. The computer 100 includes a processor 101, memory 102, a communication interface 103, an input device 104, an output device 105, and a non-volatile storage device 106. The computer 100 also includes a drive device 107 for a storage medium (i.e., recording medium) 110. The components of the computer 100 are interconnected through a bus 108.

In addition, the computer 100 is connected to a network 120. The network 120 is, for example, a local area network (LAN), a wide area network (WAN), the Internet, or a combination of them.

To the network 120, other computers 130, 140, and 150 may also be connected. The computers 130, 140, and 150 may also be configured similarly to the computer 100.

A program provider 160 may also be connected to the network 120. The program provider 160 is also a computer. The program provider 160 may also be configured similarly to the computer 100.

FIG. 2 illustrates only one processor 101, but the computer 100 may include a plurality of processors 101. Furthermore, the processor 101 may be a single-core processor, or a multi-core processor.

The processor 101 concretely may be a general-purpose central processing unit (CPU) for executing a program, or a dedicated processor such as an application-specific integrated circuit (ASIC) etc. Furthermore, the computer 100 may include both a general-purpose CPU and a dedicated processor. For example, the computer 100 may include, as an example of a dedicated processor, a multiplication circuit for multiplying big number integers.

The memory 102 may be, for example, dynamic random access memory (DRAM). The processor 101 may load a program into the memory 102, and execute the program while using the memory 102 also as a working area.

The communication interface 103 is, for example, a wired LAN interface circuit, a wireless LAN interface circuit, or a combination of them. The communication interface 103 is concretely an external network interface card (NIC), or a on-board network interface controller. For example, the communication interface 103 may include a circuit called a “PHY chip” for performing a process of a physical layer, and a circuit called a “MAC chip” for performing a process of a media access control (MAC) sublayer.

The input device 104 is, for example, a keyboard, a pointing device, a microphone, a camera, or a combination of two or more of them. The pointing device is, for example, a mouse, a touch pad, or a touchscreen. The output device 105 is a display, a speaker, or a combination of them. A display may be a touchscreen.

The non-volatile storage device 106 is, for example, a hard disk drive (HDD), a solid-state drive (SSD), or a combination of them. Furthermore, read-only memory (ROM) may also be used as the non-volatile storage device 106.

Examples of the storage medium 110 include an optical disk such as a compact disc (CD), a digital versatile disk (DVD), etc., a magneto-optical disk, a magnetic disk, a semiconductor memory card such as flash memory etc. The drive device 107 may be concretely an optical disk drive device, a magneto-optical disk drive device, or a magnetic disk drive device. The drive device 107 may be a reader and a writer for a memory card.

When the processor 101 is a CPU that executes a program as described above, the program may be preinstalled into the non-volatile storage device 106. As another example, the program may be stored in the storage medium 110 and provided. Then, the program may be read by the drive device 107 from the storage medium 110, copied to the non-volatile storage device 106, and then loaded into the memory 102. Otherwise, the program may be downloaded from the program provider 160 on the network 120 to the computer 100 through the network 120 and the communication interface 103, and installed into the computer 100.

The memory 102, the non-volatile storage device 106, and the storage medium 110 are examples of a tangible storage medium (i.e., tangible recording medium). These tangible storage media are not transitory media such as a signal carrier.

The device which receives the vector \vec{c}, which is a ciphertext, or its first element c and acquires the plaintext b by performing the decryption process in FIG. 1 is a decryption device. The device which generates the secret key (that is, the matrix V) and the public key (that is, the matrix B) is a key generation device. Focusing on the computer 100 in FIG. 2, there may be three cases as listed below.
The first case in which the computer 100 operates as a decryption device according to the flowchart in FIG. 1, but does not operate as a key generation device.
The second case in which the computer 100 operates as a key generation device and also operates as a decryption device according to the flowchart in FIG. 1.
The third case in which the computer 100 operates as a key generation device, but does not operate as a decryption device.

In the first case above, for example, the computer 130 may be a key generation device. In the first case, the computer 100 may receive the information for use in decryption, through the network 120 from the computer 130 as a key generation device. In this case, let the communication between the computer 100 and the computer 130 through the network 120 be a secure encrypted communication.

As illustrated in steps S2 to S4 in FIG. 1, the computer 100 as a decryption device uses both the element w in the matrix W and its inverse w⁻¹ in the decryption. However, it is sufficient for the computer 100 as a decryption device to receive at least one of the element w and its inverse w⁻¹ from the computer 130 as a key generation device. This is because either of the element w and the inverse w⁻¹ makes it possible to calculate the other one. That is, the computer 100 as a decryption device may acquire one of the element w and its inverse w⁻¹ by the receiving it from the computer 130, and may acquire the other one by the calculation.

Furthermore, it is possible to find the element w by searching the matrix W. Therefore, the computer 100 as a decryption device may receive, as the information for use in the decryption, not the element w and its inverse w⁻¹, but the matrix W from the computer 130 as a key generation device.

Obviously, it is possible to calculate the matrix W from the inverse matrix V⁻¹ of the secret key V and the determinant d of the matrix B. In addition, it is possible to calculate the inverse matrix V⁻¹ from the matrix V, and the matrix V is defined by the n integers v₀, . . . , vₙ₋₁. Furthermore, it is possible to acquire the determinant d from the matrix B, and it is also possible to calculate the matrix B from the matrix V.

Therefore, it is sufficient for the computer 100 as a decryption device to receive, as the information for use in the decryption, only one of the inverse matrix V⁻¹, the matrix V, and a tuple of the n integers v₀, . . . , vₙ₋₁ from the computer 130 as a key generation device. The computer 100 as a decryption device may additionally receive the matrix B or its determinant d from the computer 130 as a key generation device.

The computer 100 as a decryption device may store, in the non-volatile storage device 106, the information received in advance from the computer 130 for use in the decryption, and may read the information by referring to the non-volatile storage device 106 when performing the decryption. At least a part of the non-volatile storage device 106 may be a tamper-resistant storage device. For example, the computer 100 may acquire the element w from the non-volatile storage device 106 in step S2 in FIG. 1, and may acquire the inverse w⁻¹ from the non-volatile storage device 106 in step S3.

The computer 100 as a decryption device may receive the ciphertext vector \vec{c} or the value c of its first element, specifically from the computer 140 through the network 120. Otherwise, the computer 100 may receive the vector \vec{c} or the value c through the input device 104 of the computer 100 itself. That is, in the computer 100 as a decryption device, a ciphertext reception unit which receives the input of the ciphertext vector \vec{c} or the input of the value c may be realized by the communication interface 103 or by the input device 104.

A first acquisition unit which acquires the above-mentioned element w may be realized by the processor 101 or by the communication interface 103.

For example, the processor 101 may acquire the element w by performing the calculation using the information received from the computer 130 as a key generation device. By so doing, the processor 101 may operate as the first acquisition unit.

Otherwise, the communication interface 103 may acquire the element w by receiving the element w from the computer 130 as a key generation device over the network 120. By so doing, the communication interface 103 may operate as the first acquisition unit.

Obviously, the element w may be stored in the non-volatile storage device 106 after it is once calculated or received. In this case, the processor 101 may acquire the element w by reading the element w from the non-volatile storage device 106. By so doing, the processor 101 may operate as the first acquisition unit.

Similarly, a second acquisition unit which acquires the inverse w⁻¹ of the element w may also be realized by the processor 101 or by the communication interface 103.

For example, the processor 101 may acquire the inverse w⁻¹ by performing the calculation using the information received from the computer 130 as a key generation device. By so doing, the processor 101 may operate as the second acquisition unit.

Otherwise, the communication interface 103 may acquire the inverse w⁻¹ by receiving the inverse w⁻¹ from the computer 130 as a key generation device over the network 120. By so doing, the communication interface 103 may operate as the second acquisition unit.

Obviously, the inverse w⁻¹ may be stored in the non-volatile storage device 106 after it is once calculated or received. In this case, the processor 101 may acquire the inverse w⁻¹ by reading the inverse w⁻¹ from the non-volatile storage device 106. By so doing, the processor 101 may operate as the second acquisition unit.

In the computer 100 as a decryption device, a calculation unit which calculates the plaintext b as in step S4 in FIG. 1 is realized by the processor 101.

In addition, a plaintext output unit which outputs the plaintext b may be realized by, for example, the output device 105 which displays the plaintext, the communication interface 103, or the processor 101 which writes the plaintext b to the non-volatile storage device 106.

Also in the above-mentioned second case (that is, when the computer 100 not only operates as a decryption device, but also operates as a key generation device), the ciphertext reception unit in the decryption device may be realized by the communication interface 103 or the input device 104 as in the first case. In addition, the calculation unit in the decryption device may be realized by the processor 101 as in the first case. Furthermore, the plaintext output unit in the decryption device may be realized by the output device 105, the communication interface 103, or the processor 101 as in the first case.

When the computer 100 operates also as a key generation device, the information that the computer 100 as a decryption device uses in the decryption is the information derived from the information generated by the computer 100 itself as a key generation device. Therefore, in the second case, in which the computer 100 also operates as a key generation device, the first and second acquisition units are realized not by the communication interface 103, but by the processor 101.

In the above-mentioned second or third case, the computer 100 as a key generation device includes a generation unit which generates the n integers v₀, . . . , vₙ₋₁, which define the secret key V. Furthermore, the computer 100 as a key generation device also includes a judgment unit which judges whether the following three conditions hold true or not.
the first condition: The inverse matrix V⁻¹ exists for the n×n square matrix V defined by the n generated integers vₙ, . . . , vₙ₋₁.
the second condition: The matrix B of the specific Hermite normal form as expressed by equation (6) is derivable from the matrix V.

$$B = [ \begin{matrix}d & 0 & 0 & … & 0 \\ {b}_{21} & 1 & 0 & … & 0 \\ {b}_{31} & 0 & 1 & … & 0 \\ ⋮ & ⋮ & ⋮ & ⋱ & ⋮ \\ {b}_{n 1} & 0 & 0 & … & 1\end{matrix} ] \qquad ( 6 )$$

the third condition: An element coprime to a predetermined positive integer (that is, the plaintext space size s) exists in n×n elements of the matrix W=dV⁻¹ defined by the determinant d of the matrix B and the inverse matrix V⁻¹ of the matrix V.

The generation unit and the judgment unit are concretely realized by the processor 101. Furthermore, equation (6) indicates the followings.
For all j where 1<j≦n, the (1, j)-th element of the matrix B is 0.
For all i and j where 1<i≦n, 1<j≦n, and i≠j, the (i, j)-th element of the matrix B is 0.
For all i where 1<i≦n, the (i, i)-th element of the matrix B is 1.

When the matrix B is in the form indicated by equation (6), it is clear from the definition of the determinant that the determinant of the matrix B is equal to the (1,1)-th element of the matrix B.

Furthermore, in the computer 100 as a key generation device, the processor 101 as the generation unit repeats generating the n integers v₀, . . . , vₙ₋₁ until the n integers v₀, . . . , vₙ₋₁ which let all of the first through third conditions hold true. For example, the processor 101 may generate n random integers as the above-mentioned integers v₀, . . . , vₙ₋₁.

The computer 100 as a key generation device further includes a public key output unit which outputs the matrix B as a public key when the n integers v₀, . . . , vₙ₋₁ which let all of the first through third conditions hold true are obtained. The public key output unit may be realized by, for example, the communication interface 103. The communication interface 103 may operate as the public key output unit by transmitting the matrix B to another device (for example, the computer 140) over the network 120.

The public key B is specifically a public key of the homomorphic cryptography whose plaintext space is a set of integers not less than 0 and less than s. That is, the predetermined positive integer s in the above-mentioned third condition indicates the plaintext space size.

In the above-mentioned third case (that is, when the computer 100 is a key generation device but is not a decryption device), the computer 100 as a key generation device may transmit, to the decryption device, the information to be used in the decryption. For example, the decryption device in the third case may be the computer 150. In this case, let the communication between the computer 100 as a key generation device and the computer 150 as a decryption device over the network 120 be a secure encrypted communication. The information that the key generation device transmits, to the decryption device, as the information to be used by the decryption device in performing the decryption has been described above with reference to an example of a transmission from the computer 130 to the computer 100 with respect to the first case.

That is, in the third case, the computer 100 as a key generation device may transmit at least one of the element w and its inverse w⁻¹ to the computer 150 as a decryption device. As another example, the computer 100 as a key generation device may transmit the matrix W to the computer 150 as a decryption device. Obviously, the computer 100 as a key generation device may only transmit one of the inverse matrix V⁻¹, the matrix V, and a tuple of the n integers v₀, . . . , vₙ₋₁ to the computer 150 as a decryption device. The computer 100 as a key generation device may additionally transmit the matrix B or its determinant d to the computer 150 as a decryption device.

Described next are three comparative examples for comprehension of the above-mentioned first embodiment and the second and third embodiments described later.

The first comparative example is an example in which the plaintext space is the set {0, 1}. That is, in the first comparative example, s is 2 (s=2). In other words, the length of each plaintext in the first comparative example is one bit.

The key generation device in the first comparative example receives two parameters, the dimension n and the bit length t. The dimension n and the bit length t are integers not less than 2.

Then, the key generation device generates n random numbers v₀, . . . , vₙ₋₁. For each i where 0≦i≦n−1, the random number vᵢ is an integer and the absolute value |vᵢ| of the random number vᵢ is t bits long or shorter.

The key generation device sets, as a secret key, the matrix V defined by the n generated random numbers v₀, . . . , vₙ₋₁ as in equation (3). The key generation device sets, as a public key associated with the secret key V, the matrix B which is the Hermite normal form of the matrix V. The key generation device publishes the public key B.

An encryption device in the first comparative example encrypts a 1-bit plaintext b using the public key B as described below.

First, the encryption device selects an n-dimensional random number vector (also referred to as a noise vector) \vec{u} each of whose elements is 0 or 1. Hereafter, each element of the random number vector \vec{u} is expressed as equation (7).

\vec{u}=(u₀,u₁, . . . ,uₙ₋₁) (7)

Then, the encryption device generates the vector \vec{a} of equation (8) by using the random number vector \vec{u}. In the following decryptions, the vector \vec{a} is referred to as a “fresh ciphertext”.

$$\begin{matrix}{a}^{->} = 2 {u}^{->} + b \times {{e}^{->}}_{1} \\ = ( 2 {u}_{0} + b , 2 {u}_{1} , … , 2 {u}_{n - 1} ) \\ = ( {a}_{0} , {a}_{1} , … , {a}_{n - 1} )\end{matrix} \qquad ( 8 )$$

The vector \vec{e}₁ in equation (8) is an n-dimensional unit vector in which only the first element is 1 and all the other elements are 0. The encryption device generates a ciphertext \vec{c} corresponding to the plaintext b according to equation (9), by using the fresh ciphertext \vec{a}.

$$\begin{matrix}{c}^{->} = {a}^{->} mod B \\ = {a}^{->} - ⌈ {a}^{->} \times {B}^{- 1} ⌋ \times B\end{matrix} \qquad ( 9 )$$

The notation “B⁻¹” in equation (9) indicates the inverse matrix of the matrix B.

For any rational number q, “q┘” indicates the integer closest to the rational number q. For example, 12/5┘=2 and 14/5┘=3.

The operator “□┘” is also defined for the case where the argument is an n-dimensional vector as in equation (9). Concretely, when the argument is an n-dimensional vector, the n-dimensional vector whose i-th element is the integer closest to the i-th element of the argument vector (for each i where 1≦i≦n) is obtained as a result of the operation by the operator “□┘”.

In addition, also in the first comparative example, the matrix B is in the form of equation (6). Therefore, although the proof is omitted, all elements from the second element to the n-th element are 0 in the ciphertext obtained by equation (9).

A decryption device in the first comparative example decrypts the ciphertext \vec{c} with the secret key V as follows.

First, the decryption device calculates the n-dimensional vector \vec{a}′ of equation (10).

$$\begin{matrix}{{a}^{->}}^{′} = {c}^{->} mod V \\ = {c}^{->} - ⌈ {c}^{->} \times {V}^{- 1} ⌋ \times V \\ = ( {a}_{0}^{′} , {a}_{1}^{′} , … , {a}_{n - 1}^{′} )\end{matrix} \qquad ( 10 )$$

Next, the decryption device divides the first element a₀′ of the n-dimensional vector \vec{a}′ of equation (10) by 2, and thereby calculates the remainder. That is, the decryption device extracts from the first element a₀′ the least significant bit (LSB) as a decryption result. The remainder obtained as described above (that is, the LSB of the first element a₀′) is a result of decrypting the ciphertext \vec{c}.

Described below are numerical examples for the key generation, encryption, and decryption in the above-mentioned first comparative example. In the examples below, let the dimension n be 4, and the bit length t be 7. Since the bit length t is 7, the key generation device generates n (=4) integers whose absolute values are not more than 127 (=2⁷−1). For example, assume that the four random numbers of v₀=112, v₁=99, v₂=−125, and v₃=81 are obtained.

In this case, the secret key V is expressed by equation (11).

$$V = [ \begin{matrix}112 & 99 & - 125 & 81 \\ - 81 & 112 & 99 & - 125 \\ 125 & - 81 & 112 & 99 \\ - 99 & 125 & - 81 & 112\end{matrix} ] \qquad ( 11 )$$

In addition, from the matrix V, the key generation device calculates the matrix B, which is the Hermite normal form of the matrix V. As a result, the matrix B of equation (12) is obtained as a public key. Note that the matrix B of equation (12) has the form of equation (6).

$$B = [ \begin{matrix}1143821449 & 0 & 0 & 0 \\ 982623548 & 1 & 0 & 0 \\ 480851699 & 0 & 1 & 0 \\ 190648369 & 0 & 0 & 1\end{matrix} ] \qquad ( 12 )$$

Described next is the process in which the encryption device encrypts the plaintext b which is 1. First, the encryption device generates a 4-dimensional random number vector \vec{u}. For convenience of explanation, let the 4-dimensional random number vector \vec{u} as expressed by equation (13) be generated.

\vec{u}=(1,0,1,1) (13)

Next, the encryption device calculates the fresh ciphertext \vec{a} according to equation (8) from the obtained 4-dimensional random number vector \vec{a}. Specifically, the fresh ciphertext \vec{a} as in equation (14) is obtained.

$$\begin{matrix}{a}^{->} = 2 {u}^{->} + b \times {{e}^{->}}_{1} \\ = 2 \times ( 1 , 0 , 1 , 1 ) + 1 \times ( 1 , 0 , 0 , 0 ) \\ = ( 3 , 0 , 2 , 2 )\end{matrix} \qquad ( 14 )$$

Next, the encryption device calculates the ciphertext \vec{c} according to equation (9) from the obtained fresh ciphertext \vec{a}. Concretely, the ciphertext \vec{c} as in equation (15) is obtained.

$$\begin{matrix}{c}^{->} = {a}^{->} mod B \\ = {a}^{->} - ⌈ {a}^{->} \times {B}^{- 1} ⌋ \times B \\ = {a}^{->} - ⌈ ( - 1343000133 / 1143821449 , 0 , 2 , 2 ) ⌋ \times B \\ = ( 3 , 0 , 2 , 2 ) - ( - 1 , 0 , 2 , 2 ) \times B \\ = ( - 199178684 , 0 , 0 , 0 )\end{matrix} \qquad ( 15 )$$

Then, the ciphertext \vec{c} (or its first element) is transmitted to the decryption device. Then, the decryption device calculates the 4-dimensional vector \vec{a}′ according to equation (10). Concretely, the 4-dimensional vector \vec{a}′ as in equation (16) is obtained.

$$\begin{matrix}{{a}^{->}}^{′} = {c}^{->} mod V \\ = {c}^{->} - ⌈ {c}^{->} \times {V}^{- 1} ⌋ \times V \\ = ( 3 , 0 , 2 , 2 )\end{matrix} \qquad ( 16 )$$

Then, the decryption device divides the first element (that is, the value of 3) of the 4-dimensional vector \vec{a}′ by 2, and thereby obtains the remainder, i.e., 1. The obtained value of 1 is the value acquired by the decryption. In the above-mentioned numerical examples, the original plaintext b, which is 1, is correctly acquired.

The detailed explanation is omitted, but in the homomorphic cryptography in the first comparative example, as indicated by the calculation examples in equations (14) and (16), the vector \vec{a} is identical with the vector \vec{a}′. This fact is derived from the property of the integer lattice, which provides the mathematical foundations of the first comparative example. The fact that the vector \vec{a} and the vector \vec{a}′ are identical with each other enables the decryption of a ciphertext.

However, in the first comparative example, there is the demerit that it takes a long time to perform the decryption according to equation (10) (that is, the processing load of the decryption is heavy) especially when the dimension n is high. This is because, as indicated by equation (10), the multiplication of an n-dimensional vector and an n×n matrix is performed twice in the decryption. Furthermore, when the bit length t is large, the multiplication of an element of a vector and an element of a matrix may be an operation on big numbers, thereby further increasing the processing load of the decryption.

Therefore, it is preferable to reduce the processing load of the decryption and thereby realize the decryption at a high speed. The second comparative example described below is an example in which the decryption of the first comparative example is modified so that the decryption is performed at a higher speed. Since the key generation and encryption in the second comparative example are identical to those in the first comparative example, the explanation of them is omitted here.

A decryption device in the second comparative example calculates the plaintext b according to equation (17), by using the first element c of the ciphertext vector \vec{c}.

b=[c×w]_{d} mod 2 (17)

The scalar “w” in equation (17) is an odd number in the elements of the matrix W=dV⁻¹ defined by the determinant d of the public key B and the inverse matrix V⁻¹ of the secret key V. Also in the second comparative example, since the public key B has the form of equation (6), the determinant d of the public key B is equal to the (1,1)-th element of the matrix B.

In addition, for the same reason as described with respect to the first embodiment, the value of each element in the second row through the n-th row of the matrix W is either equal to the value of an element of one of the columns in the first row of the matrix W, or equal to the product of −1 and the value of an element of one of the columns in the first row of the matrix W. Therefore, the scalar w in equation (17) is any odd number included in the first row of the matrix W or the product of −1 and such an odd number.

Furthermore, the notation “[c×w]_{d}” in equation (17) indicates the value obtained by adjusting (c×w mod d) so that the obtained value is included in the interval [−d/2, d/2) (refer to equation (5) above for details).

The first and second comparative examples are based on the lattice theory. The fact that the two equal signs in equation (18) hold true is derived under the condition that the n-dimensional vector \vec{a}′ obtained by equation (10) is equal to the fresh ciphertext \vec{a} of equation (8).

[\vec{c}×W]_{d}=[\vec{a}×W]_{d}=\vec{a}×W (18)

The operator “[•]_{d}” is defined for the case where the argument is an n-dimensional vector as in equation (18). Concretely, the operator “[•]_{d}” which takes an n-dimensional vector as the argument indicates that the operator “[•]_{d}” defined by equation (5) is applied to each of the n elements of the n-dimensional argument vector. Therefore, an n-dimensional vector is acquired as a result.

The detailed proof is omitted here, but equation (17) is mathematically equivalent to the equation “b=a₀′ mod 2”. Therefore, the decryption by equation (17) is correct. The correctness of the decryption is derived from equation (18), the fact that the second through n-th elements of the ciphertext \vec{c} are all 0, and the definition of equation (8).

As it is clear from equation (17), the multiplication of a vector and a matrix is not performed in the decryption in the second comparative example. The multiplication “c×w” in equation (17) is merely a multiplication of scalars. Therefore, the processing load of the decryption in the second comparative example is much lower than that in the first comparative example. That is, the decryption in the second comparative example is performed much faster than the decryption in the first comparative example.

In both the first and second comparative examples, a plaintext is 1-bit information. In a system in which only 1-bit plaintexts are usable, a plurality of plaintexts are combined to express complicated information, and each of the plaintexts is encrypted. Therefore, compared with a system in which a plaintext of 2 bits or longer is usable, various processes such as a totalizing operation are complicated, thereby taking a longer processing time.

Therefore, for applications to a variety of fields, it is desirable to extend the plaintext space. The third comparative example described next is an example in which s>2. That is, compared with the first comparative example, the plaintext space of the third comparative example is extended.

The key generation (that is, the generation of the matrix V as a secret key, and the generation of the matrix B as a public key) in the third comparative example is identical to that in the first and second comparative examples. Therefore, the explanation of the key generation is omitted here.

An encryption device in the third comparative example generates the n-dimensional random number vector \vec{u} of equation (7), as with the encryption device in the first comparative example. Next, the encryption device generates a fresh ciphertext \vec{a} according to equation (19).

$$\begin{matrix}{a}^{->} = s \times {u}^{->} + b \times {{e}^{->}}_{1} \\ = ( s \times {u}_{0} + b , s \times {u}_{1} , … , s \times {u}_{n - 1} ) \\ = ( {a}_{0} , {a}_{1} , … , {a}_{n - 1} )\end{matrix} \qquad ( 19 )$$

As clearly understood by comparing equation (8) with equation (19), equation (8) corresponds to a special case of equation (19) where s=2.

Then, the encryption device generates the ciphertext \vec{c} corresponding to the plaintext b according to equation (9), by using the fresh ciphertext \vec{a}. In the ciphertext \vec{c} thus obtained in the third comparative example, all the elements other than the first element are 0. Therefore, it is possible to regard the ciphertext \vec{c} as its first element \vec{c}. The ciphertext \vec{c} corresponds, in one-to-one manner, to the fresh ciphertext \vec{a}.

A decryption device in the third comparative example decrypts the ciphertext \vec{c} as described below. First, the decryption device calculates the n-dimensional vector \vec{a}′ of equation (19). Next, the decryption device calculates the plaintext b according to equation (20), by using the first element a₀′ of the n-dimensional vector \vec{a}′.

b=a₀′ mod s (20)

Although the proof is omitted, the n-dimensional vector \vec{a}′ of equation (10) is identical with the fresh ciphertext \vec{a} of equation (19) also in the third comparative example. Therefore, equation (21) holds true. Accordingly, the plaintext b is correctly obtained by equation (20).

a₀′=a₀=s×u₀+b (21)

As described above, in the third comparative example, a plaintext b of 2 bits or longer (concretely, a plaintext which is an integer not less than 0 and not more than (s−1)) is available. However, the decryption in the third comparative example is performed at a low speed.

The reason is that, as it is clear from equation (10), the multiplication of the n-dimensional vector and the n×n matrix is performed twice (in other words, the multiplication of scalars is performed 2×n² times) in the decryption in the third comparative example. Furthermore, when the bit length t is large, the multiplication of scalars may be an operation on big numbers and therefore the processing load of the decryption becomes heavier, and it takes a longer time to perform the decryption.

On the other hand, in the first embodiment described above with reference to FIGS. 1 and 2, the merit that a high-speed decryption is feasible because the processing load of the decryption is light is compatible with the merit that the plaintext space is extended. Therefore, the first embodiment is more advantageous than any of the above-described first through third comparative examples. Similarly, the second and third embodiments described later are more advantageous than any of the first through third comparative examples.

Next, for assistance in understanding the reduction in the processing load of the decryption in the first through third embodiments, the decryption in the third comparative example is described below in detail with reference to FIGS. 3 through 6.

FIG. 3 is a block diagram of the decryption device according to the third comparative example. A decryption device 200 illustrated in FIG. 3 includes an input/output unit 201, a control unit 202, an inverse matrix calculation unit 203, a fresh ciphertext calculation unit 204, a vector-matrix multiplication unit 205, a scalar multiplication unit 206, a rounding unit 207, a subtraction unit 208 and a modulo operation unit 209.

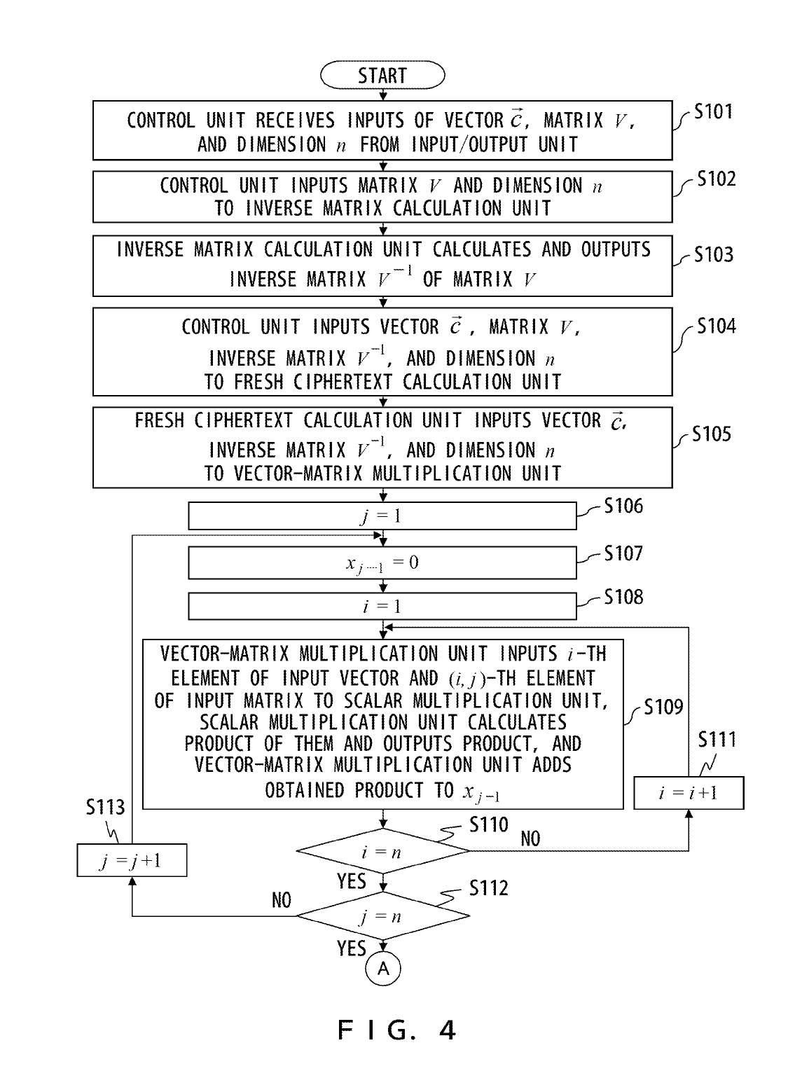

The input/output unit 201 operates as an input interface for input to the decryption device 200, and also operates as an output interface for output from the decryption device 200. The control unit 202 receives the input about a ciphertext \vec{c}, the input about a secret key V, and the input about the dimension n through the input/output unit 201, controls the decrypting process, and outputs the plaintext b obtained as a result of the decryption to the input/output unit 201. The operation of each unit other than the input/output unit 201 and the control unit 202 is described later with reference to FIGS. 4 through 6.

The decryption device 200 may also be a computer such as the computer 100 in FIG. 2, for example. In this case, the input/output unit 201 may be specifically realized by a combination of one or more of the input device 104, the output device 105, the non-volatile storage device 106, and the communication interface 103. In this case, each unit other than the input/output unit 201 in the decryption device 200 may be realized by the processor 101.

FIGS. 4 through 6 are flowcharts of the decryption method executed by the decryption device 200 of the third comparative example.

In step S101, the control unit 202 receives the following information from the input/output unit 201.
the vector \vec{c}, which is a ciphertext
the matrix V, which is the secret key
the dimension n of the matrix V

Next, in step S102, the control unit 202 inputs, as arguments, the matrix V and the dimension n to the inverse matrix calculation unit 203.

Then, in step S103, the inverse matrix calculation unit 203 calculates the inverse matrix V⁻¹ of the matrix V, and outputs the inverse matrix V⁻¹ to the control unit 202. Any specific method for calculating the inverse matrix may be used. For example, the inverse matrix calculation unit 203 may calculate the inverse matrix V⁻¹ by the Gauss-Jordan elimination.

Next, in step S104, the control unit 202 inputs the following information, as arguments, to the fresh ciphertext calculation unit 204.
the vector \vec{c} input from the input/output unit 201
the matrix V input from the input/output unit 201
the inverse matrix V⁻¹ calculated by the inverse matrix calculation unit 203
the dimension n input from the input/output unit 201

The fresh ciphertext calculation unit 204 is a component which calculates the vector \vec{a}′ of equation (10). As described above, in the third comparative example, since the fresh ciphertext \vec{a} of equation (19) is equal to the vector \vec{a}′ of equation (10), the vector \vec{a}′ of equation (10) may also be called a “fresh ciphertext” in the following description. For the same reason, the component which calculates the vector \vec{a}′ of equation (10) is called a “fresh ciphertext calculation unit” as described above.

Upon receipt of the above-mentioned inputs, the fresh ciphertext calculation unit 204 first inputs the following information, as arguments, to the vector-matrix multiplication unit 205 in step S105 in order to obtain the product of the vector \vec{c} and the inverse matrix V⁻¹ in equation (10).
the vector \vec{c} input from the control unit 202
the inverse matrix V⁻¹ input from the control unit 202
the dimension n input from the control unit 202

Upon receipt of the dimension n, an n-dimensional row vector, and an n×n square matrix as inputs, the vector-matrix multiplication unit 205 calculates the product of the input vector and the input matrix (that is, calculates an n-dimensional row vector), and outputs the calculated product. For convenience of explanation below, let the output vector output from the vector-matrix multiplication unit 205 be expressed by equation (22).

\vec{x}=(x₀,x₁, . . . ,xₙ₋₁) (22)

Therefore, upon receipt of the above-mentioned inputs in step S105, the vector-matrix multiplication unit 205 multiplies the vector \vec{c} by the inverse matrix V⁻¹, and outputs the obtained product \vec{c}×V₋₁ to the fresh ciphertext calculation unit 204. More specifically, the multiplication and the output by the vector-matrix multiplication unit 205 are performed as follows in steps S106 through S114.

First, in step S106, the vector-matrix multiplication unit 205 initializes the index variable j to 1.

Next, in step S107, the vector-matrix multiplication unit 205 initializes the variable indicating the j-th element of the output vector \vec{x} to 0. For convenience of explanation below, this variable is also expressed as “xⱼ₋₁” according to the notation of equation (22).

Next, in step S108, the vector-matrix multiplication unit 205 initializes the index variable i to 1.

Then, in step S109, the vector-matrix multiplication unit 205 inputs, to the scalar multiplication unit 206, the i-th element of the input vector and the (i,j)-th element of the input matrix (that is, the element in the j-th column in the i-th row) as arguments. When the ciphertext C and the inverse matrix V⁻¹ of the secret key V are input to the vector-matrix multiplication unit 205 in step S105 as described above, the i-th element of the ciphertext \vec{c} and the (i,j)-th element of the inverse matrix V⁻¹ are input to the scalar multiplication unit 206 in step S109.

The scalar multiplication unit 206 calculates the product of two scalars that are input from the vector-matrix multiplication unit 205, and outputs the calculated product to the vector-matrix multiplication unit 205. Then, the vector-matrix multiplication unit 205 adds the obtained product to the variable xⱼ₋₁.

Afterwards, in step S110, the vector-matrix multiplication unit 205 judges whether or not the value of the index variable i is equal to the dimension n.

If i≠n (more specifically, if i<n), the calculation of the j-th element xⱼ₋₁ of the output vector \vec{x} has not been completed yet. Therefore, the decrypting process of FIGS. 4 through 6 proceeds to step S111.

On the other hand, if i=n, the calculation of the j-th element xⱼ₋₁ of the output vector \vec{x} has been completed. Therefore, the decrypting process proceeds to step S112.

In step S111, the vector-matrix multiplication unit 205 increments the index variable i by 1. Then, the decrypting process returns to step S109.

Meanwhile, in step S112, the vector-matrix multiplication unit 205 judges whether or not the value of the index variable j is equal to the dimension n.

If j#n (more specifically, if j<n), the calculation of the output vector \vec{x} has not been completed yet. Therefore, the decrypting process proceeds to step S113.

On the other hand, if j=n, the calculation of the output vector \vec{x} has been completed. Therefore, the decrypting process proceeds to step S114.

In step S113, the vector-matrix multiplication unit 205 increments the index variable j by 1. Then, the decrypting process returns to step S107.

Then, in step S114, the vector-matrix multiplication unit 205 outputs the calculated vector \vec{x} to the fresh ciphertext calculation unit 204. The vector thus output in step S114 is concretely \vec{c}×V⁻¹ in equation (10).

Next, in step S115, the fresh ciphertext calculation unit 204 inputs the following information, as arguments, to the rounding unit 207.
the vector output from the vector-matrix multiplication unit 205 in step S114
the dimension n input from the control unit 202

Then, in step S116, the rounding unit 207 calculates and outputs the n-dimensional vector in which, for each i where 1≦i≦n, the i-th element is the integer closest to the i-th element of the input n-dimensional vector. The vector thus output in step S116 is concretely \vec{c}×V⁻¹┘ in equation (10).

Next, the fresh ciphertext calculation unit 204 inputs the following information, as arguments, to the vector-matrix multiplication unit 205 in step S117 in order to obtain \vec{c}×V⁻¹┘×V in equation (10).
the n-dimensional vector \vec{c}×V⁻¹┘ output from the rounding unit 207 in step S116
the matrix V input from the control unit 202
the dimension n input from the control unit 202

The subsequent steps S118 through S126 are similar to steps S106 through S114. More specifically, in step S118, the vector-matrix multiplication unit 205 initializes the index variable j to 1.

Next, in step S119, the vector-matrix multiplication unit 205 initialize the variable indicating the j-th element of the output vector \vec{x} to 0.

Next, in step S120, the vector-matrix multiplication unit 205 initializes the index variable i to 1.

Then, in step S121, the vector-matrix multiplication unit 205 inputs the i-th element of the input vector and the (i,j)-th element of the input matrix (that is, the element in the j-th column in the i-th row) as arguments to the scalar multiplication unit 206. The scalar multiplication unit 206 calculates the product of the two scalars input from the vector-matrix multiplication unit 205, and outputs the calculated product to the vector-matrix multiplication unit 205. Then, the vector-matrix multiplication unit 205 adds the obtained product to the variable xⱼ₋₁.

Afterwards, in step S122, the vector-matrix multiplication unit 205 judges whether or not the value of the index variable i is equal to the dimension n. If i≠n (more specifically, if i<n), the decrypting process proceeds to step S123. On the other hand, if i=n, the decrypting process proceeds to step S124.

In step S123, the vector-matrix multiplication unit 205 increments the index variable i by 1. Then, the decrypting process returns to step S121.

In step S124, the vector-matrix multiplication unit 205 judges whether or not the value of the index variable j is equal to the dimension n. If j≠n (more specifically, if j<n), the decrypting process proceeds to step S125. On the other hand, if j=n, the decrypting process proceeds to step S126.

In step S125, the vector-matrix multiplication unit 205 increments the index variable j by 1. Then, the decrypting process returns to step S119.

Then, in step S126, the vector-matrix multiplication unit 205 outputs the calculated vector \vec{x} to the fresh ciphertext calculation unit 204. The vector thus output in step S126 is concretely \vec{c}×V⁻¹×V in equation (10).

Then, in step S127, the fresh ciphertext calculation unit 204 inputs the following information, as arguments, to the subtraction unit 208.
the vector \vec{c} input from the control unit 202
the vector output from the vector-matrix multiplication unit 205 in step S126 (that is, \vec{c}×V⁻¹┘×V)
the dimension n input from the control unit 202

Then, in step S128, the subtraction unit 208 calculates the difference between the two input n-dimensional vectors. That is, the subtraction unit 208 calculates the vector \vec{a}′ of equation (10). Then, the subtraction unit 208 outputs the calculated vector \vec{a}′ to the fresh ciphertext calculation unit 204.

As described above, the vector \vec{a}′ of equation (10) is equal to the fresh ciphertext \vec{a}. Therefore, the process in step S128 is, in other words, the process that the subtraction unit 208 calculates and outputs the fresh ciphertext \vec{a}.

Then, in step S129, the fresh ciphertext calculation unit 204 outputs the fresh ciphertext \vec{a} obtained as described above to the control unit 202.

Then, in step S130, the control unit 202 inputs the following information, as arguments, to the modulo operation unit 209.
the first element a₀ of the fresh ciphertext \vec{a} output from the fresh ciphertext calculation unit 204
the constant s indicating the plaintext space size

Then, in step S131, the modulo operation unit 209 calculates the plaintext b according to equation (23), and outputs the calculated plaintext b to the control unit 202. Since a₀′=a₀ as described above, equation (23) is equivalent to equation (20).

b=a₀ mod s(23)

Finally, in step S132, the control unit 202 outputs the plaintext b through the input/output unit 201. Then, the decrypting process of the third comparative example terminates.

As described above, in the third comparative example, step S109 is performed n² times and step S121 is performed n² times in the decryption of each single ciphertext. That is, in the third comparative example, the multiplication by the scalar multiplication unit 206 is performed 2×n² times in the decryption of each single ciphertext. Therefore, the processing load of the decryption in the third comparative example is heavy, and it takes a long time to perform decryption in the third comparative example.

The merits of the first embodiment illustrated in FIGS. 1 and 2 is described below with reference to the above-mentioned first through third comparative examples.

As compared with the first and second comparative examples, the first embodiment has the merit of being suitable to be applied to various uses since the plaintext space is extended.

For example, as cloud services have become widely used recently, the secret totalization for totalizing data while keeping each individual piece of data encrypted has attracted much attention. The homomorphic cryptography is expected to be applied to various uses such as secret totalization etc. Therefore, the first embodiment, in which the plaintext space is extended (that is, the plaintext space size s is larger than 2), excels the first and second comparative examples in variety of application fields.

Furthermore, as compared with the third comparative example, the first embodiment has the merit that a high-speed decryption is feasible because the number of times of multiplications to be performed is much smaller.

Concretely, in the third comparative example, the multiplication of scalar values is performed 2×n² times for each execution of the decryption, as described above. Even if the fact that the second through n-th elements of the ciphertext \vec{c} are all 0 may be taken into consideration and the third comparative example may be modified, by taking advantage of this fact, so that the execution of the multiplication by 0 may be omitted, each execution of the decryption in the thus-modified third comparative example still involves performing multiplication of scalar values (n+n²) times.

On the other hand, in the first embodiment, the plaintext b is calculated by equation (4) in step S4 in FIG. 1. For convenience of reference, equation (4) is described again below. The number of multiplications of scalar values included in equation (4) is only two.

b=[c×w]_{d}×w⁻¹ mod s (4)

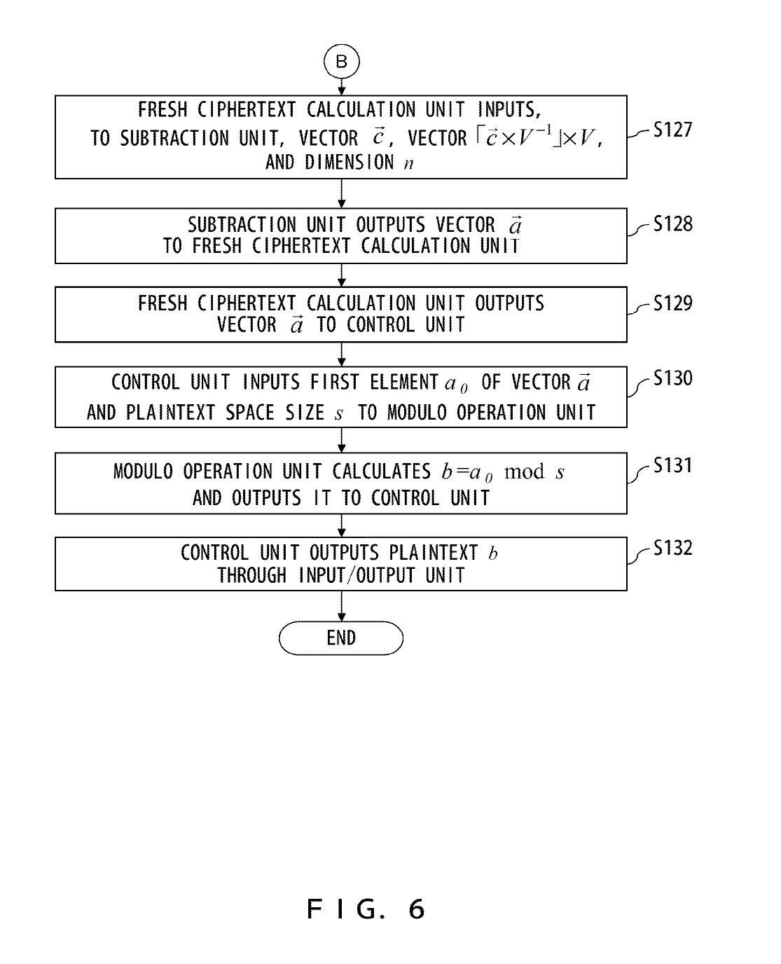

In the first embodiment, as expressed by equation (4), the modulo operation is performed twice for each decrypting process. On the other hand, in the third comparative example, as indicated by step S131 in FIG. 6, the number of times that the modulo operation is performed for each decrypting process is one. In addition, the computational cost of the modulo operation is not low.

However, the influence of the increase in the computational cost due to one more modulo operation, which is additional as compared with the third comparative example, is very small. When the computational cost of the decryption in the third comparative example is compared with that in the first embodiment, what is dominant is the influence of the fact that the number of times that the multiplication is performed is much reduced in the first embodiment.

Furthermore, the first embodiment enables the decryption at a lower computational cost than that of the third comparative example even if the cost of acquiring the value w in step S2 in the first embodiment and the cost of acquiring the inverse w⁻¹ in step S3 are taken into account.

As described above, there are various specific methods for acquiring the values in steps S2 and S3. For example, the computer may acquire the value w in step S2 by reading the value w from the storage device, and may acquire the inverse w⁻¹ in step S3 by reading the inverse w⁻¹ from the storage device. In this case, the acquisition costs insteps S2 and S3 are negligibly low.

As another example, the computer may acquire the element win step S2 by searching the matrix W for the element w coprime to the plaintext space size s. In this case, as described above, it is sufficient for the computer to search the n elements in any one row or any one column in the matrix W for the element w coprime to the plaintext space size s. That is, even when the matrix W is not stored in advance in the storage device of the computer, it is sufficient for the computer, in step S2, to calculate the n elements in the matrix W and search the n elements for an element coprime to the plaintext space size s.

In addition, if the inverse matrix V⁻¹ is known, it is sufficient for the computer to perform the multiplication of scalars n times for calculation of the values of the n elements in the matrix W because W=dV⁻¹. Obviously, the time taken to perform the multiplication n times is sufficiently shorter than the time taken to perform the multiplication 2×n² times (or (n+n²) times).

Furthermore, when the determinant d of the matrix B, which is used as a public key, is coprime to the plaintext space size s, the computer may acquire the value w as follows in step S2. That is, the computer may search the n elements in any row or any column in the matrix V⁻¹ for an element coprime to the plaintext space size s. Then, the computer may acquire the value w by multiplying the element found in the search by the above-mentioned determinant d. In this case, the number of times that the multiplication is performed in step S2 is only one.

That is, even if, in step S2, the computer calculates the matrix W from the inverse matrix V⁻¹ and acquires the value w by searching the matrix W, the number of times that the multiplication is performed in step S2 is not more than n. Furthermore, even when the multiplication is performed n times in step S2, the cost of the multiplication in step S2 is low in the aspect of the cost per one execution of the decryption. The reason is as follows.

The value w used in the decryption in the first embodiment does not depend on the ciphertext, as it is clear from the definition. Therefore, even if the computer acquires the value w by the calculation and the search in order to decrypt a certain ciphertext, it is possible to reduce the acquisition cost of the value w per one execution of the decryption by storing the once acquired value w in the storage device, and reading the stored value w when decrypting another ciphertext. Similarly, even if the computer acquires the inverse w⁻¹ by calculating it at least once, it is possible to reduce the acquisition cost of the inverse w⁻¹ per one execution of the decryption by storing the once acquired inverse w⁻¹ in the storage device.

On the other hand, in the third comparative example, as it is clear from equation (10) and FIGS. 4 through 6, vectors acquired in the course of decrypting a certain ciphertext are not relevant to the decryption of another ciphertext. That is, since all of the following three vectors depend on the ciphertext \vec{c}, they are not relevant to the decryption of another ciphertext. Therefore, they are not reusable for the decryption of another ciphertext.
\vec{c}×V⁻¹
┌\vec{c}×V⁻¹ ┘
┌\vec{c}×V⁻¹ ┘×V

Therefore, in the third comparative example, even if the inverse matrix V⁻¹ is calculated in advance and reused each time the decryption is performed, the computational cost which may be reduced, per one execution of the decryption, by reusing the inverse matrix V⁻¹ is limited. That is, in the third comparative example, even if the inverse matrix V⁻¹ is reused, it is still the case that the multiplication of the n-dimensional vector and the n×n matrix is performed twice to perform the decryption. The computational cost of these two multiplications is not removed by reusing the result of the calculation.

Therefore, when the computational cost per one execution of the decryption is compared between the third comparative example and the first embodiment, the influence of the cost in steps S2 and S3 is negligible. In addition, as described above, the computational cost in step S4 is much lower than the computational cost of the decryption in the third comparative example.

The computer in the first embodiment may perform the Montgomery modular multiplication instead of the ordinary multiplication and modulo operation in step S4 in order to further reduce the computational cost.

As described above, the first embodiment has the merit that a high-speed decryption is realized in the homomorphic cryptography with an extended plaintext space.

In the first embodiment, the plaintext b is obtained by equation (4) as described above. Comparing equation (17) used in the second comparative example with equation (4), it is understood that equation (4) is a generalized form of equation (17). That is, equation (4) is applicable to any s where s≧2, and equation (17) indicates the case in which s=2.

For convenience of reference, equations (4) and (17) are listed below again.

b=[c×w]_{d}×w⁻¹ mod s (4)

b=[c×w]_{d} mod 2 (17)

As described above, w in equation (4) is coprime to s. Therefore, when s=2 in equation (4), win equation (4) is an odd number. Therefore, when s=2 in equation (4), w⁻¹ in equation (4) is also an odd number (because w⁻¹ in equation (4) is the inverse of w modulo s). Therefore, when s=2, equation (24) is derived from equation (4) since w⁻¹ is an odd number.

$$\begin{matrix}b = {[ c \times w ]}_{d} \times {w}^{- 1} mod 2 \\ = {[ c \times w ]}_{d} mod 2\end{matrix} \qquad ( 24 )$$

As understood by comparing equation (24), which is thus obtained by substituting s=2 into equation (4), with equation (17), equation (4) is a generalized form of equation (17).

Described next is the reason why the plaintext b is obtained by equation (4) in the first embodiment. In other words, described below is the reason why equation (4) is mathematically equivalent to equation (23), which relates to the value a₀ (=a₀′) obtained by equation (10).

Also in the third comparative example, in which the plaintext space size s is larger than 2, equation (10) indicates a fresh ciphertext as described above. That is, equation (25) holds true also when s>2.

$$\begin{matrix}{a}^{->} = {{a}^{->}}^{′} \\ = {c}^{->} mod V \\ = {c}^{->} - ⌈ {c}^{->} \times {V}^{- 1} ⌋ \times V\end{matrix} \qquad ( 25 )$$

Equation (26) is derived from equation (25) and the definition “W=dV⁻¹” described above.

$$\begin{matrix}{a}^{->} = {c}^{->} \times {V}^{- 1} \times V - ⌈ {c}^{->} \times {V}^{- 1} ⌋ \times V \\ = ( {c}^{->} \times {V}^{- 1} - ⌈ {c}^{->} \times {V}^{- 1} ⌋ ) \times V \\ = [ {c}^{->} \times {V}^{- 1} ] \times V \\ = [ {c}^{->} \times W / d ] \times V\end{matrix} \qquad ( 26 )$$

For any rational number q, “[q]” indicates the difference between the rational number q and the integer closest to the rational number q. That is, for any rational number q, equation (27) holds true.

[q]=q−┌q┘ (27)

For example, since 13/5┘=3, [13/5]=13/5−3=−2/5. When the argument of the operator “[•]” is an n-dimensional vector as in equation (26), the operator “[•]” for the n-dimensional vector indicates that the operator “[•]” of equation (27) for a scalar is applied to each of the n elements of the n-dimensional argument vector. Therefore, an n-dimensional vector is obtained as a result.

Equation (28) is derived by multiplying both sides of equation (26) by the matrix W (because d×[z/d]=[z]_{d} for any integer z). The character “I” in equation (28) indicates an n×n identity matrix.

$$\begin{matrix}{a}^{->} \times W = [ {c}^{->} \times W / d ] \times V \times W \\ = [ {c}^{->} \times W / d ] \times d I \\ = d \times [ {c}^{->} \times W / d ] \\ = {[ {c}^{->} \times W ]}_{d}\end{matrix} \qquad ( 28 )$$

The encryption method corresponding to the decryption method according to the first embodiment is the same as the encryption method of the third comparative example. That is, the encryption in the first embodiment includes the following two steps.
generating a fresh ciphertext \vec{a} according to equation (19) by using a random number vector \vec{a}.
generating a ciphertext \vec{c} from the fresh ciphertext \vec{a} according to equation (9).

Since the matrix V has the regularity as indicated in equation (3), the matrix W also has the regularity as described above. More specifically, the matrix W has the form as indicated in equation (29).

$$W = [ \begin{matrix}{w}_{0} & {w}_{1} & {w}_{2} & … & {w}_{n - 1} \\ - {w}_{n - 1} & {w}_{0} & {w}_{1} & … & {w}_{n - 2} \\ - {w}_{n - 2} & - {w}_{n - 1} & {w}_{0} & … & {w}_{n - 3} \\ ⋮ & ⋮ & ⋮ & ⋱ & ⋮ \\ - {w}_{1} & - {w}_{2} & - {w}_{3} & … & {w}_{0}\end{matrix} ] \qquad ( 29 )$$

Equation (30) is derived by substituting equations (19) and (29) into equation (28).

$$\begin{matrix}{[ {c}^{->} \times W ]}_{d} = {a}^{->} \times W \\ = ( s \times {u}^{->} + b \times {{e}^{->}}_{1} ) \times W \\ = s \times {u}^{->} \times W + b \times ( {w}_{0} , {w}_{1} , … , {w}_{n - 1} )\end{matrix} \qquad ( 30 )$$

On the other hand, when noting that all of the second element to the n-th element of the ciphertext \vec{c} are 0, equation (31) is obtained.

$$\begin{matrix}{[ {c}^{->} \times W ]}_{d} = {[ ( c , 0 , … , 0 ) \times W ]}_{d} \\ = {[ ( {cw}_{0} , {cw}_{1} , … , {cw}_{n - 1} ) ]}_{d} \\ = ( {[ {cw}_{0} ]}_{d} , {[ {cw}_{1} ]}_{d} , … , {[ {cw}_{n - 1} ]}_{d} )\end{matrix} \qquad ( 31 )$$

When equation (30) is compared with equation (31), it is understood that the equal sigh of equation (32) holds true modulo s.

([cw₀]_{d},[cw₁]_{d}, . . . ,[cwₙ₋₁]_{d})=(bw₀,bw₁, . . . ,bwₙ₋₁)(mod s) (32)

The fact that the equal sign of equation (32) holds true modulo s indicates that the equal sign of equation (33) holds true modulo s for any i where 0≦i≦n−1.

[cwᵢ]_{d}=bwᵢ(mod s) (33)

If an element wᵢ coprime to the plaintext space size s exists in the matrix W (where 0≦i≦n−1) the inverse wᵢ⁻¹ modulo s exists for the element wᵢ. That is, for any i where 0≦i≦n−1, equation (34) holds true (the function “gcd( )” in equation (34) indicates the greatest common divisor of its two arguments).

(gcd(s,wᵢ)=1) [symbol] (∃wᵢ⁻¹,wⁱ×wᵢ⁻¹=1(mod s)) (34)

In the first embodiment, the value w acquired in step S2 in FIG. 1 is an element coprime to the plaintext space size s in the elements of the matrix W, as described above. Therefore, according to equation (34), the inverse w⁻¹ modulo s exists for the value w. This inverse w⁻¹ is acquired in step S3 in FIG. 1.

Since the matrix W has the regularity as indicated in equation (29), in step S2, the computer according to the first embodiment may search, for example, the elements w₀, w₁, . . . , wₙ₋₁ in the first row of the matrix W for an element coprime to the plaintext space size s.

For convenience of explanation below, let an element wᵢ be coprime to the plaintext space size s (where 0≦i≦n−1). Furthermore, as described above, for any i where 0≦i≦n−1, the equal sign of equation (33) holds true modulo s. Therefore, equation (35) holds true with respect to the element wᵢ coprime to the plaintext space size s.

$$\begin{matrix}b = b \times {w}_{i} \times {w}_{i}^{- 1} mod s \\ = {[ c \times {w}_{i} ]}_{d} \times {w}_{i}^{- 1} mod s\end{matrix} \qquad ( 35 )$$

Equation (35) is the same as equation (4) used in step S4 in the first embodiment. That is, as it is clear from the explanation above, the decryption in the first embodiment is semantically (that is, mathematically) equivalent to the decryption in the third comparative example. Therefore, just as the decryption in the third comparative example is correct, the decryption according to equation (4) in the first embodiment is also correct.

However, although the decryption in the first embodiment and that in the third comparative example are mathematically equivalent, they are quite different in computational complexity. That is, as described above, the decryption in the first embodiment is performed much faster than the decryption in the third comparative example. Therefore, the first embodiment excels the third comparative example. That is, according to an aspect, the decryption in the third comparative example with a large computational complexity is, in the first embodiment, replaced with the decryption which is mathematically equivalent to the decryption in the third comparative example but has a much smaller computational complexity.

Next, as more concrete variations of the first embodiment, the second and third embodiments are described below. The explanation of the common points with the first embodiment may be omitted hereafter.

In the second embodiment, the decryption device also serves as a key generation device. That is, the second embodiment corresponds to the case where the computer which performs the decrypting process in FIG. 1 serves as both a key generation device and a decryption device.

On the other hand, the third embodiment is an embodiment in which the computational cost of the decryption is further reduced by using the value w and inverse w⁻¹ stored in advance. The third embodiment is applicable regardless of whether the decryption device also serves as a key generation device or not. The third embodiment corresponds to the case in which the acquisition in step S2 and that in step S3 in FIG. 1 are realized by the processes of reading a value from a storage device.

Each of the second and third embodiments is concretely described below. FIG. 7 is a block diagram of an information processing device 300 according to the second embodiment.

The information processing device 300 illustrated in FIG. 7 is a key generation device, and also a decryption device. The information processing device 300 may be specifically realized by the computer 100 in FIG. 2.

The information processing device 300 includes an input/output unit 301 and a control unit 302. The information processing device 300 also includes a random number generation unit 303, an inverse matrix calculation unit 304, an HNF (Hermite normal form) calculation unit 305, a scalar-matrix multiplication unit 306, a scalar multiplication unit 307, a search unit 308, and a GCD (greatest common divisor) calculation unit 309. Furthermore, the information processing device 300 includes an inverse element calculation unit 310, a storage unit 311, a decryption unit 312, a first modulo operation unit 313, and a second modulo operation unit 314.

The input/output unit 301 operates as an input interface for input to the information processing device 300, and also operates as an output interface for output from the information processing device 300. For example, the input/output unit 301 as an input interface may be realized by one or both of the communication interface 103 and the input device 104. The input/output unit 301 as an output interface may be realized by one or both of the communication interface 103 and the output device 105. In some cases, the input/output unit 301 may be realized by a data input/output interface (for example, a disk controller) between the non-volatile storage device 106 and the processor 101.

The control unit 302 controls both key generation and decryption. The control unit 302 may be realized by, for example, the processor 101.

Specifically in the second embodiment, the control unit 302 receives the input of the bit length t, the input of the dimension n, and the input of the plaintext space size s from the input/output unit 301, and controls the key generation according to the received inputs. The control unit 302 publishes the generated public key (that is, the matrix B) through the input/output unit 301.

Furthermore, the control unit 302 receives, as a ciphertext, the vector \vec{c} or its first element c through the input/output unit 301. Upon receipt of the ciphertext, the control unit 302 starts the decrypting process. In addition, the control unit 302 outputs the plaintext b, which is obtained as a result of the decryption, through the input/output unit 301.

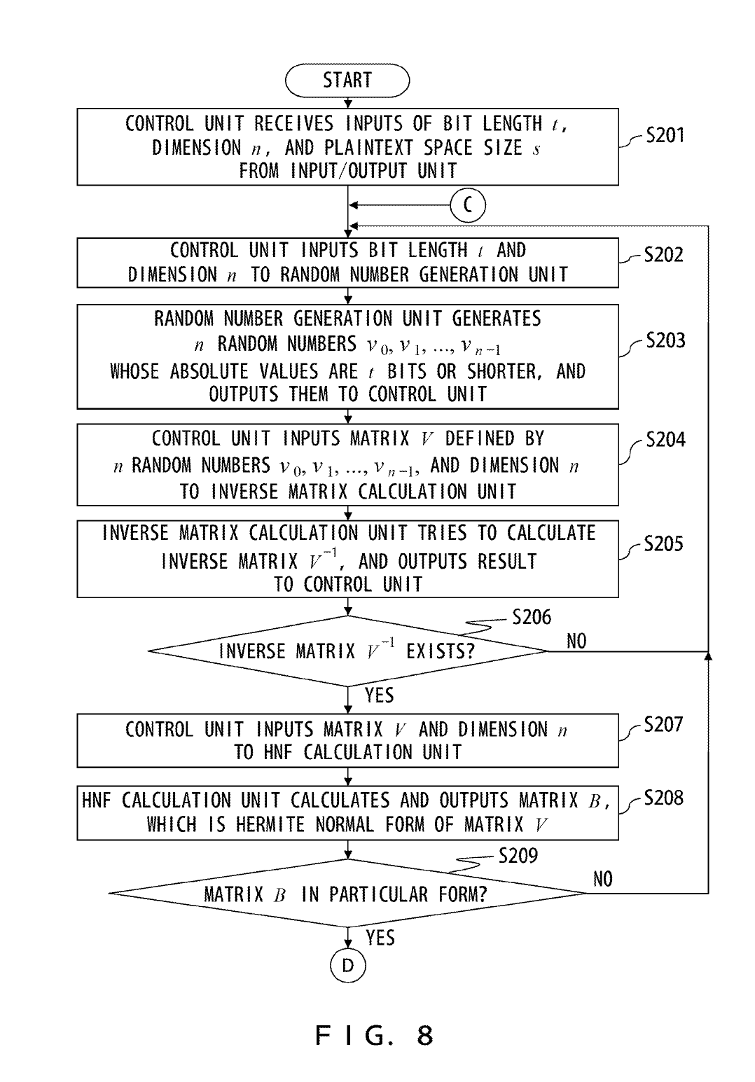

The details of each unit other than the input/output unit 301 and the control unit 302 are described later with reference to FIGS. 8 through 11, but the outline of each unit is described next.

The random number generation unit 303 is related to the generation of a secret key, and the HNF calculation unit 305 is related to the generation of a public key. The inverse matrix calculation unit 304, the scalar-matrix multiplication unit 306, the search unit 308, and the GCD calculation unit 309 are related to the judgment as to whether or not the secret key satisfies the conditions to enable a high-speed decryption. Furthermore, the search unit 308 and the GCD calculation unit 309 are also related to the acquisition of the information for use in the decryption. Furthermore, the inverse element calculation unit 310 is also related to the acquisition of the information for use in the decryption.

The storage unit 311 stores the information for use in the decryption. The storage unit 311 may be realized by the non-volatile storage device 106.

The decryption unit 312, the first modulo operation unit 313, and the second modulo operation unit 314 are related to the decryption. The scalar multiplication unit 307 is a module to be used by both the scalar-matrix multiplication unit 306 and the decryption unit 312.

When the information processing device 300 is realized by the computer 100, the following units may be realized by the processor 101.
the control unit 302
the random number generation unit 303
the inverse matrix calculation unit 304
the HNF calculation unit 305
the scalar-matrix multiplication unit 306
the scalar multiplication unit 307
the search unit 308
the GCD calculation unit 309
the inverse element calculation unit 310
the decryption unit 312
the first modulo operation unit 313
the second modulo operation unit 314

FIGS. 8 through 10 are flowcharts of the process performed by the information processing device 300 according to the second embodiment.

In step S201, the control unit 302 receives the input of the bit length t, the input of the dimension n, and the input of the plaintext space size s from the input/output unit 301. The bit length t, the dimension n, and the plaintext space size s are values independent of one another.

For example, the bit length t may be 32, 64, 128, or other values. As the dimension n, values such as 1024 (=2¹⁰), 2048 (=2¹¹), 4096 (=2¹²), 8192 (=2¹³), 16384 (=2¹⁴), 32768 (=2¹⁵), etc. are preferable. The larger the bit length t and the dimension n are, the lower the risk that a secret key is broken becomes and hence the higher the security level is. The dimension n exemplified above is preferable because it is well balanced between the security level and the processing speed. However, it is obvious that the dimension n is arbitrary.

The plaintext space size s may be appropriately determined, for example depending on the purpose of using the homomorphic cryptography. Also in the second embodiment, s>2 as in the first embodiment.

It is preferable that the plaintext space size s is a power of two or a prime number. This is because, when the plaintext space size s is a power of two or a prime number, the process of searching for an element coprime to the plaintext space size s is simple and therefore does not lead to a heavy load.

That is, when the plaintext space size s is a power of two, the process of searching for an element coprime to the plaintext space size s is the process of searching for an odd element (that is, the process of searching for an element whose least significant bit (LSB) is 1), and the load of this process is low. Furthermore, when the plaintext space size s is a prime number, the process of searching for an element coprime to the plaintext space size s is the process of searching for an element which is not a multiple of s, and the load of this process is relatively low.

Next, in step S202, the control unit 302 inputs the bit length t and the dimension n, as arguments, to the random number generation unit 303.

Then, the random number generation unit 303 generates n random numbers v₀, v₁, . . . , vₙ₋₁, and outputs the n generated random numbers v₀, v₁, . . . , vₙ₋₁ to the control unit 302 in step S203. To be more specific, for each i where 0≦i≦n−1, the random number vᵢ is an integer and the absolute value |vᵢ| of the random number vᵢ is t bits or shorter.

Next, in step S204, the control unit 302 inputs the n×n square matrix V defined by the n random numbers v₀, v₁, . . . , vₙ₋₁ as in equation (3) and the dimension n, as arguments, to the inverse matrix calculation unit 304. The matrix V is a candidate for a secret key.

Then, in step S205, the inverse matrix calculation unit 304 tries to calculate the inverse matrix V⁻¹ of the matrix V, and outputs the result to the control unit 302. For example, the inverse matrix calculation unit 304 may try to calculate the inverse matrix V⁻¹ by the Gauss-Jordan elimination. Furthermore, the inverse matrix calculation unit 304 may call the scalar multiplication unit 307 for calculation of the inverse matrix V.

The matrix V is defined as described above based on the random numbers. Therefore, there may be a case where the inverse matrix V⁻¹ exists for the matrix V incidentally, and there may also be a case where no inverse matrix V⁻¹ exists for the matrix V incidentally.

Accordingly, when it is found out that the inverse matrix V¹ exists for the matrix V, the inverse matrix calculation unit 304 outputs the inverse matrix V⁻¹ to the control unit 302. On the other hand, when it is found out that no inverse matrix V⁻¹ exists for the matrix V, the inverse matrix calculation unit 304 outputs, to the control unit 302, a return value or an error code etc. which indicate that no inverse matrix V⁻¹ exists.

Then, in step S206, the control unit 302 judges whether the inverse matrix V⁻¹ exists for the matrix V or not based on the output from the inverse matrix calculation unit 304. The judgment in step S206 corresponds to the judgment as to whether the “first condition” holds true or not in the explanation above about the case in which the computer 100 in FIG. 2 operates as a key generation device.

When no inverse matrix V⁻¹ exists, the matrix V is not appropriate as a secret key. Therefore, when no inverse matrix V⁻¹ exists, the processing returns to step S202 in order to test another new matrix as a candidate for a secret key.

On the other hand, when the inverse matrix V⁻¹ exists, the processing proceeds to step S207 in order to check two more conditions (that is, the “second condition” and the “third condition” described above with reference to FIG. 2) about whether or not the matrix V is appropriate as a secret key.

In step S207, the control unit 302 inputs the matrix V and the dimension n, as arguments, to the HNF calculation unit 305.

Then, in step S208, the HNF calculation unit 305 calculates the matrix B, which is the Hermite normal form of the matrix V, and outputs the matrix B to the control unit 302. The HNF calculation unit 305 may call the scalar multiplication unit 307 for the calculation of the matrix B.

Next, in step S209, the control unit 302 judges, based on the output from the HNF calculation unit 305, whether or not the matrix B is in a particular form (more specifically, the form of equation (6)). The judgment in step S209 corresponds to the judgment as to whether the “second condition” holds true or not in the explanation above about the case in which the computer 100 in FIG. 2 operates as a key generation device.

When the matrix B is not in the form of equation (6) (that is, when the Hermite normal form having the form of equation (6) is not derivable from the matrix V), the matrix V is not appropriate as a secret key. Therefore, in this case, the processing returns to step S202 in order to test another new matrix as a candidate for a secret key.

On the other hand, when the matrix B is in the form of equation (6), the processing proceeds to step S210 in order to further check the remaining condition (that is, the “third condition” explained above with reference to FIG. 2) as to whether the matrix V is appropriate as a secret key or not.

In step S210, the control unit 302 inputs the following information, as arguments, to the scalar-matrix multiplication unit 306.
the inverse matrix V⁻¹ output from the inverse matrix calculation unit 304
the dimension n input from the input/output unit 301
the determinant d (that is, the (1,1)-th element) of the matrix B output from the HNF calculation unit 305

Then, insteps S211 through S218, the scalar-matrix multiplication unit 306 calculates the matrix W (=dV⁻¹).

Specifically, in step S211, the scalar-matrix multiplication unit 306 initializes the index variable i to 1.

Next, in step S212, the scalar-matrix multiplication unit 306 initializes the index variable j to 1.

Then, in step S213, the scalar-matrix multiplication unit 306 inputs the following two values, as arguments, to the scalar multiplication unit 307.
the determinant d input from the control unit 302
the (i, j)-th element of the inverse matrix V⁻¹ input from the control unit 302

Then, in step S214, the scalar multiplication unit 307 multiplies the two input values together, and outputs the product obtained as a result of the multiplication to the scalar-matrix multiplication unit 306. Then, the scalar-matrix multiplication unit 306 sets the output from the scalar multiplication unit 307 as the (i,j)-th element of the matrix W.

Next, in step S215, the scalar-matrix multiplication unit 306 judges whether or not the value of the index variable j is equal to the dimension n.

If j≠n, (more specifically, if j<n), there remains an element whose value has not been set yet in the i-th row of the matrix W. Therefore, the processing proceeds to step S216.

On the other hand, if j=n, it means that all of the values of the n elements in the i-th row of the matrix W have been calculated. Therefore, the processing proceeds to step S217.

In step S216, the scalar-matrix multiplication unit 306 increments the index variable j by 1. Then, the processing returns to step S213.

In step S217, the scalar-matrix multiplication unit 306 judges whether or not the value of the index variable i is equal to the dimension n.

If i≠n (more specifically, if i<n), there remains a row to whose elements values have not been set yet in the matrix W. Therefore, the processing proceeds to step S218.

On the other hand, if i=n, it means that all of the values of the n×n elements in the matrix W have been calculated. Therefore, the processing proceeds to step S219.

In step S218, the scalar-matrix multiplication unit 306 increments the index variable i by 1. Then, the processing returns to step S212.

On the other hand, in step S219, the scalar-matrix multiplication unit 306 outputs the matrix W to the control unit 302.

Then, in step S220, the control unit 302 inputs the following information, as arguments, to the search unit 308.
the matrix W output from the scalar-matrix multiplication unit 306
the dimension n input from the input/output unit 301
the plaintext space size s input from the input/output unit 301

Next, in steps S221 through 229, the search unit 308 judges whether or not there is an element w coprime to the plaintext space size s in the elements of the matrix W.

Specifically, in step S221, the search unit 308 initializes the index variable i to 1.

Next, in step S222, the search unit 308 initializes the index variable j to 1.

Then, in step S223, the search unit 308 inputs the following two values, as arguments, to the GCD calculation unit 309.
the (i,j)-th element of the matrix W input from the control unit 302
the plaintext space size s input from the control unit 302

Then, in step S224, the GCD calculation unit 309 calculates the greatest common divisor (GCD) of the two input values, and outputs the calculated GCD to the search unit 308. The GCD calculation unit 309 may calculate the GCD by the Euclidean algorithm, for example.

Next, in step S225, the search unit 308 judges whether or not the GCD output from the GCD calculation unit 309 is 1.

When the GCD is 1, the (i, j)-th element of the matrix W is coprime to the plaintext space size s. That is, when the GCD is 1, there is an element coprime to the plaintext space size s in the matrix W. Accordingly, when the GCD is 1, the “third condition” explained above with reference to FIG. 2 holds true. Therefore, in this case, the processing proceeds to step S230.

On the other hand, if the GCD is not 1, the search for an element coprime to the plaintext space size s continues. Therefore, the processing proceeds to step S226.

In step S226, the search unit 308 judges whether or not the value of the index variable j is equal to the dimension n.

If j#n (more specifically, if j<n), there remains, in the i-th row of the matrix W, an element which has not been checked yet as to whether it is coprime to the plaintext space size s or not. Therefore, the processing proceeds to step S227.

On the other hand, if j=n, no element in the i-th row of the matrix W is coprime to the plaintext space size s. Therefore, the processing proceeds to step S228.

In step S227, the search unit 308 increments the index variable j by 1. Then, the processing returns to step S223.

In step S228, the search unit 308 judges whether or not the value of the index variable i is equal to the dimension n.

If i≠n (more specifically, if i<n), there remains an unchecked row in the matrix W. Therefore, the processing proceeds to step S229.

On the other hand, if i=n, none of the n×n elements of the matrix W is coprime to the plaintext space size s. In this case, the high-speed decryption like in step S4 in FIG. 1 according to the first embodiment is not applied. That is, in this case, the matrix V is not an appropriate matrix as a secret key that enables a high-speed decryption. Therefore, in this case, the search unit 308 notifies the control unit 302 that there is no element coprime to the plaintext space size s in the matrix W. Then, the processing returns to step S202 in order to test another new matrix as a candidate for a secret key.

In step S229, the search unit 308 increments the index variable i by 1. Then, the processing returns to step S222.

Step S230 is performed when it is found out that the matrix V is appropriate as a secret key that enables a high-speed decryption. That is, step S230 is performed when it is found out that all of the following three conditions hold true.
the first condition: The inverse matrix V⁻¹ exists for the n×n square matrix V defined by the n generated integers v₀, . . . , vₙ₋₁.
the second condition: The matrix B of the Hermite normal form as in equation (6) is derivable from the matrix V.
the third condition: There is an element coprime to the plaintext space size s in the n×n elements of the matrix W (=dV⁻¹).

When the three conditions above hold true, the matrix V as a candidate for a secret key is appropriate as a secret key, and the matrix B as a candidate for a public key is appropriate as a public key. Therefore, the control unit 302 decides that the matrix V is a secret key and that the matrix B is a public key. More specifically, in step S230, the following process is performed.

First, the search unit 308 outputs the (i,j)-th element w of the matrix W to the control unit 302. That is, the search unit 308 outputs, to the control unit 302, the element w which has turned out, in step S225, to be coprime to the plaintext space size s.

Then, the control unit 302 inputs the following two values, as arguments, to the inverse element calculation unit 310.
the element w output from the search unit 308
the plaintext space size s input from the input/output unit 301

Next, in step S231, the inverse element calculation unit 310 calculates the inverse w⁻¹ of the value w modulo s.

When step S231 is performed, the two values w and s are coprime to each other. Therefore, the inverse w⁻¹ exists for the value w modulo s. Accordingly, the inverse element calculation unit 310 is enabled to obtain the inverse w⁻¹.

The inverse element calculation unit 310 outputs the inverse w⁻¹ to the control unit 302. Then, the control unit 302 stores the following four values in the storage unit 311.
the plaintext space size s input from the input/output unit 301
the determinant d of the matrix B output from the HNF calculation unit 305 (that is, the (1,1)-th element of the public key B)
the element w output from the search unit 308 (that is, the element coprime to the plaintext space size s in the matrix W (=dV⁻¹))
the inverse w⁻¹ output from the inverse element calculation unit 310

Furthermore, in the next step S232, the control unit 302 publishes the public key B through the input/output unit 301. For example, when the information processing device 300 is the computer 100 in FIG. 2, the input/output unit 301 may transmit the public key B to the computer 140 through the network 120, thereby publishing the public key B. Obviously, upon request from any other device, the information processing device 300 may transmit the public key B to the requesting device at any time.

Then, the control unit 302 waits for the reception of an input of a ciphertext, as indicated in step S233. When the control unit 302 receives an input of a ciphertext, the processing proceeds to step S234.

In step S234, the decrypting process for decrypting the received ciphertext is performed. The decrypting process is described later in detail with reference to FIG. 11. When the decrypting process is completed, the processing illustrated in FIGS. 8 through 10 returns to step S233.

The ciphertext received by the control unit 302 may be specifically the n-dimensional vector \vec{c}, all the elements of which are 0 except the first element, or may be the first element c of the n-dimensional vector \vec{c}. If the control unit 302 receives the n-dimensional vector as a ciphertext, the control unit 302 extracts the first element c and starts the decrypting process of step S234, using the extracted first element c as a ciphertext.

Furthermore, the ciphertext received by the control unit 302 may be a ciphertext which has been obtained from one plaintext, or may be a ciphertext which has been obtained from a plurality of plaintexts.

More specifically, the control unit 302 may receive, through the input/output unit 301, a ciphertext obtained by a certain device (for example, the computer 140 in FIG. 2) encrypting a certain single plaintext (specifically, an integer not less than 0 and less than s) with the public key B. Otherwise, the control unit 302 may receive, through the input/output unit 301, a single ciphertext obtained as a result of a certain operation performed on a plurality of ciphertexts (note that the encryption function with the public key B in the second embodiment is homomorphic).

For example, a certain device may perform a certain operation on M ciphertexts (M≦2) without decrypting the M ciphertexts, where each of the M ciphertexts is obtained by encrypting each of M plaintexts with the public key B and each of the M plaintexts is an integer not less than 0 and less than s. The M ciphertexts may be obtained by, for example, a single device encrypting each of the M plaintexts, or may be obtained by M devices each encrypting a single plaintext.

In any case, when there are M ciphertexts, a certain operation may be performed on the M ciphertexts. The certain operation may be constituted by, for example, one or more additions, a multiplication(s) not more than a predetermined number of times, or a combination of an addition(s) and a multiplication(s) not more than a predetermined number of times.

Furthermore, the device which performs the certain operation on the M ciphertexts may be the device which encrypts a plaintext or plaintexts, or may be another device. In some cases, the information processing device 299 may receive the M ciphertexts through the network 120, perform a certain operation on the M ciphertexts, and output the result of the certain operation to the control unit 302.

Anyhow, there is a case in which one ciphertext is obtained as a result of a certain operation performed on the M ciphertexts. The one ciphertext thus obtained may be received by the control unit 302.

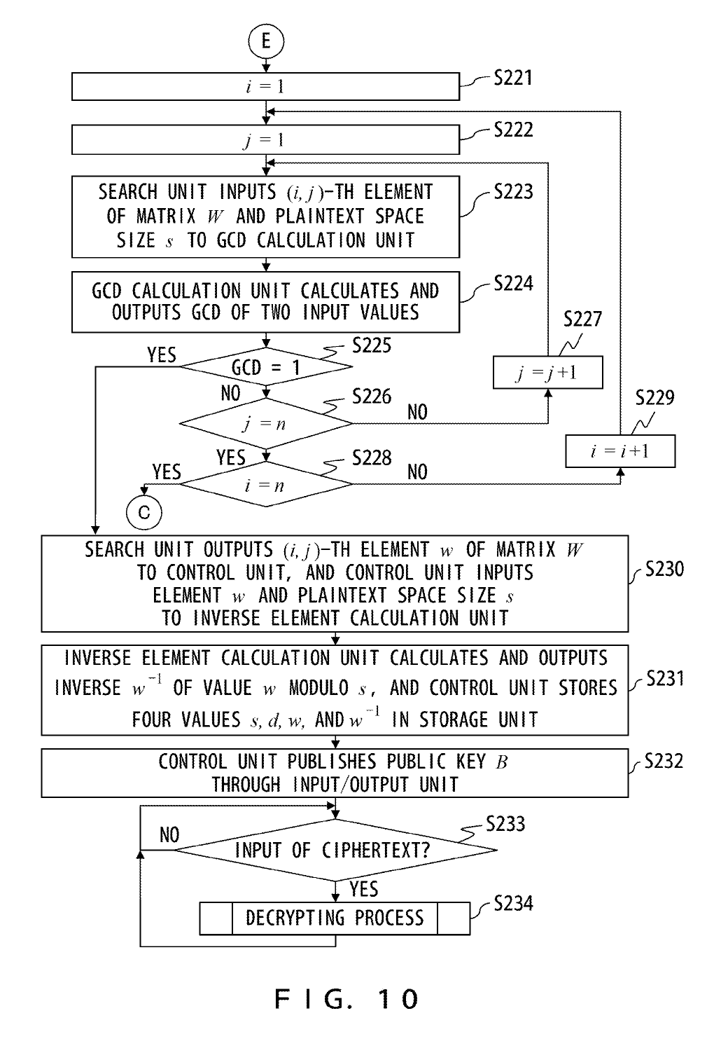

FIG. 11 is a flowchart for illustrating the details of the decrypting process in step S234 in FIG. 10. The decrypting process in FIG. 11 is common to the second and third embodiments. As described above, the decrypting process in FIG. 11 is performed on the first element c of the n-dimensional vector \vec{c}.

In step S301, the control unit 302 reads the following four values from the storage unit 311, and inputs the four read values and the ciphertext c, as arguments, to the decryption unit 312.
the element w coprime to the plaintext space size s in the matrix W (=dV⁻¹)
the inverse w⁻¹
the plaintext space size s
the determinant d of the public key B

Next, in step S302, the decryption unit 312 inputs the following two values, as arguments, to the scalar multiplication unit 307.
the ciphertext c input from the control unit 302
the value w input from the control unit 302

Then, in step S303, the scalar multiplication unit 307 calculates the product (c×w) of the two input values c and w, and outputs the calculated product (c×w) to the decryption unit 312.

Then, in step S304, the decryption unit 312 inputs the following two values, as arguments, to the first modulo operation unit 313.
the value (c×w) output from the scalar multiplication unit 307
the value d input from the control unit 302

Then, in step S305, the first modulo operation unit 313 calculates the value [c×w]_{d} from the two input values, and outputs the calculated value [c×w]_{d} to the decryption unit 312. That is, the first modulo operation unit 313 performs the operation defined by equation (5).

Next, in step S306, the decryption unit 312 inputs the following two values, as arguments, to the scalar multiplication unit 307.
the value [c×w]_{d} output from the first modulo operation unit 313
the value w⁻¹ input from the control unit 302

Then, in step S307, the scalar multiplication unit 307 calculates the product ([c×w]_{d}×w⁻¹) of the two input values [c×w]_{d} and w⁻¹, and outputs the calculated product ([c×w]_{d}×w⁻¹) to the decryption unit 312.

Then, in step S308, the decryption unit 312 inputs the following two values, as arguments, to the second modulo operation unit 314.
the value ([c×w]_{d}×w⁻¹) output from the scalar multiplication unit 307
the value s input from the control unit 302

Then, in step S309, the second modulo operation unit 314 calculates the remainder from the two input values. The second modulo operation unit 314 is a component which calculates the remainder “z₁ modulo z₂”, which may be abbreviated as “z₁ mod z₂”, when receiving inputs of any two integers z₁ and z₂ (where z₂≠0). Therefore, in step S309, the second modulo operation unit 314 specifically calculates the value b of equation (4), which is indicated below again.

b=[c×w]_{d}×w⁻¹ mod s (4)

Then, the second modulo operation unit 314 outputs the calculated value b to the decryption unit 312. Then, in step S310, the decryption unit 312 outputs the value b to the control unit 302. The value b thus output is the plaintext corresponding to the ciphertext c.

Finally, in step S311, the control unit 302 outputs, through the input/output unit 301, the plaintext b output from the decryption unit 312. Then, the decrypting process in FIG. 11 terminates.

The second embodiment described above corresponds to FIG. 1 of the first embodiment as follows.

In the second embodiment, the process of searching for the value w is performed in the course of the key generation in steps S201 through S229 (in more detail, in the course of checking in steps S221 through S229 as to whether the “third condition” holds true or not). Then, the found value w is stored in the storage unit 311 in step S231.

Therefore, in the second embodiment, the control unit 302 is able to acquire the value w from the storage unit 311 in the decrypting process of FIG. 11, which is performed each time a new ciphertext is input (more specifically, the control unit 302 is able to acquire the value w from the storage unit 311 in step S301, which corresponds to step S2 in FIG. 1). That is, the acquisition of the value w in step S2 in FIG. 1 directly corresponds to step S301 in FIG. 11, while being indirectly based on the processes in steps S220 through S229. According to another aspect, the acquisition of the value w in step S2 in FIG. 1 includes, in the second embodiment, the searching process insteps S220 through S229 in the key generating phase and the reading process in step S301 in the decrypting phase.

Furthermore, in the second embodiment, when the key generation is completed (that is, when a secret key V which satisfies the first through third conditions is found), the inverse w⁻¹ of the value w is calculated in step S231, and stored in the storage unit 311.

Therefore, in the second embodiment, the control unit 302 is able to acquire the inverse w⁻¹ from the storage unit 311 in the decrypting process of FIG. 11, which is performed each time a new ciphertext is input (more specifically, the control unit 302 is able to acquire the inverse w⁻¹ from the storage unit 311 in step S301, which also corresponds to step S3 in FIG. 1). That is, the acquisition of the inverse w⁻¹ in step S3 in FIG. 1 directly corresponds to step S301 in FIG. 11, while being indirectly based on the calculation in step S231. According to another aspect, the acquisition of the inverse w⁻¹ in step S3 in FIG. 1 includes, in the second embodiment, the calculation in step S231 and the reading process in step S301.

Furthermore, in the second embodiment, step S4 in FIG. 1 specifically corresponds to steps S302 through S309 in FIG. 11. That is, in the second embodiment, the process in step S4 includes the following operations.
the multiplication of the value c and the value w in step S303
the modulo operation with modulus d in step S305
the multiplication of the value [c×w]_{d} and the inverse w⁻¹ in step S307
the modulo operation with modulus s in step S309

However, in some embodiments, the Montgomery modular multiplication may be performed instead of the combination of the multiplication and the modulo operation. For example, the information processing device 300 may include a hardware circuit for the Montgomery modular multiplication. Otherwise, the information processing device 300 may be realized by the computer 100, and the processor 101 in the computer 100 may execute a program module for the Montgomery modular multiplication.

Furthermore, in some embodiments, in step S231, the control unit 302 may store, instead of the value w, the secret key V itself or a tuple of the n random numbers v₀, . . . , vₙ₋₁, which define the secret key V, in the storage unit 311. In this case, each time a new ciphertext is input, the information processing device 300 may perform the following processes using the information stored in the storage unit 311, thereby acquiring the value w. That is, there may be an embodiment in which, each time the decryption is performed, the information processing device 300 performs the following processes as the processes corresponding to step S2 in FIG. 1.
the calculation of the inverse matrix V⁻¹ as in steps S204 and S205
the calculation of the matrix W as in steps S210 through S219
the search as in steps S220 through S229

Furthermore, in some embodiments, the control unit 302 may store, in step S231, the inverse matrix V⁻¹ of the secret key V instead of the value w in the storage unit 311. In this case, each time a new ciphertext is input, the information processing device 300 may perform the following processes using the inverse matrix V⁻¹ stored in the storage unit 311, thereby acquiring the value w. That is, there may be an embodiment in which, each time the decryption is performed, the information processing device 300 performs the following processes as the processes corresponding to step S2 in FIG. 1.
the calculation of the matrix W as in steps S210 through S219
the search as in steps S220 through S229

Furthermore, in some embodiments, in step S231, the control unit 302 may store the matrix W instead of the value w in the storage unit 311. In this case, each time a new ciphertext is input, the information processing device 300 may acquire the value w by performing the search as in steps S220 through S229 using the matrix W stored in the storage unit 311. That is, there may be an embodiment in which, each time the decryption is performed, the information processing device 300 performs the search as in steps S220 through S229, as the process corresponding to step S2 in FIG. 1.

However, in the second embodiment, for efficiency and higher speed performance in the decrypting process, the value w is stored in the storage unit 311 in step S231, and the stored value w is read in step S301.

Furthermore, there may be an embodiment in which the inverse w⁻¹ is not calculated in advance in step S231. That is, each time a new ciphertext is input, the control unit 302 may instruct the inverse element calculation unit 310 to calculate the inverse w⁻¹, and the inverse element calculation unit 310 may calculate the inverse w⁻¹. That is, there may also be an embodiment in which, each time the decryption is performed, the information processing device 300 performs the calculation as in step S231, as the process corresponding to step S3 in FIG. 1.

However, in the second embodiment, the inverse w⁻¹ is calculated in advance and stored in the storage unit 311 in step S231 for efficiency and higher performance in the decrypting process.

In the second embodiment, as indicated in steps S210 through S219, all the n² elements of the matrix W are calculated. In the second embodiment, as indicated insteps S220 through S229, there may be a case in which it is judged, on every one of the n² elements of the matrix W, whether or not the element is coprime to the plaintext space size s.

However, for further efficiency of the process, it is possible to take advantage of the regularity of the matrix W as indicated by equation (29). For example, the control unit 302 may control the scalar-matrix multiplication unit 306 to calculate only the n elements in one arbitrary row or one arbitrary column of the matrix W. Then, the control unit 302 may control the search unit 308 to search these n calculated elements for an element coprime to the plaintext space size s.

For example, steps S217 and S218 may be omitted. In this case, if j=n in step S215, the processing proceeds to step S219. According to the modification above, the control unit 302 may control the scalar-matrix multiplication unit 306 to calculate only the n elements in the first row of the matrix W.

In addition, steps S228 and S229 may be omitted. In this case, if j=n in step S226, the processing returns to step S202. According to the modification above, the control unit 302 may control the search unit 308 to search the n elements in the first row of the matrix W for an element coprime to the plaintext space size s.

Described below is numerical examples relating to the second embodiment.

Assume that the control unit 302 receives the following inputs from the input/output unit 301 in step S201 in FIG. 8.
t=7
n=4
s=5

Furthermore, assume that the random number generation unit 303 generates the following random numbers in step S203. The absolute values of the following four random numbers are t bits or shorter. That is, the absolute values of these four random numbers are not more than 127 (=2⁷−1).
v₀=112
v₂=99
v₂=−125
v₃=81

In this case, the matrix V input to the inverse matrix calculation unit 304 in step S204 is indicated by equation (36).

$$V = [ \begin{matrix}112 & 99 & - 125 & 81 \\ - 81 & 112 & 99 & - 125 \\ 125 & - 81 & 112 & 99 \\ - 99 & 125 & - 81 & 112\end{matrix} ] \qquad ( 36 )$$

Therefore, in step S205, the inverse matrix calculation unit 304 outputs the inverse matrix V⁻¹ of equation (37) to the control unit 302. That is, the inverse matrix V⁻¹ exists for the matrix V of equation (36). Therefore, the processing proceeds from step S206 to step S207.

$${V}^{- 1} = [ \begin{matrix}\frac{5356184}{1143821449} & \frac{1247697}{1143821449} & \frac{1879255}{1143821449} & \frac{- 4142277}{1143821449} \\ \frac{4142277}{1143821449} & \frac{5356184}{1143821449} & \frac{1247697}{1143821449} & \frac{1879255}{1143821449} \\ \frac{- 1879255}{1143821449} & \frac{4142277}{1143821449} & \frac{5356184}{1143821449} & \frac{1247697}{1143821449} \\ \frac{- 1247697}{1143821449} & \frac{- 1879255}{1143821449} & \frac{4142277}{1143821449} & \frac{5356184}{1143821449}\end{matrix} ] \qquad ( 37 )$$

Then, in step S208, the HNF calculation unit 305 outputs the matrix B of equation (38) to the control unit 302. Since the matrix B of equation (38) is in the form of equation (6), the processing proceeds from step S209 to step S210.

$$B = [ \begin{matrix}1143821449 & 0 & 0 & 0 \\ 982623548 & 1 & 0 & 0 \\ 480851699 & 0 & 1 & 0 \\ 190648369 & 0 & 0 & 1\end{matrix} ] \qquad ( 38 )$$

According to equation (38), d=1143821449. Therefore, upon receipt of the inputs of the inverse matrix V⁻¹, the dimension n, and the determinant d of the matrix B in step S210, the scalar-matrix multiplication unit 306 calculates the matrix W of equation (39) in steps S211 through S218.

$$W = d {V}^{- 1} = [ \begin{matrix}5356184 & 1247697 & 1879255 & - 4142277 \\ 4142277 & 5356184 & 1247697 & 1879255 \\ - 1879255 & 4142277 & 5356184 & 1247697 \\ - 1247697 & - 1879255 & 4142277 & 5356184\end{matrix} ] \qquad ( 39 )$$

Then, the scalar-matrix multiplication unit 306 outputs the matrix W of equation (39) in step S219. As exemplified, for example, in equation (39), the matrix W has the regularity as in equation (29).

Then, in response to the instruction from the control unit 302 in step S220, the search unit 308 searches the matrix W for an element coprime to the plaintext space size s (=5). According to equation (39), the (1,1)-th element of the matrix W is coprime to the plaintext space size s.

Therefore, the processing proceeds from step S225 to step S230 when i=1 and j=1. Then, in step S230, the search unit 308 outputs the (1,1)-th element of the matrix W (that is, the value of 5356184) to the control unit 302. Then, the control unit 302 inputs the following two values to the inverse element calculation unit 310.
w=5356184
s=5

Then, in step S231, the inverse element calculation unit 310 calculates the inverse w⁻¹ of the value w modulo s as indicated by equation (40) below.

w⁻¹=4(mod 5) (40)

Furthermore, in step S231, the inverse element calculation unit 310 outputs the inverse w⁻¹ (=4) to the control unit 302. Then, the control unit 302 stores the following four values in the storage unit 311.
s=5
d=1143821449
w=5356184
w⁻¹=4

Furthermore, in step S232, the matrix B of equation (38) is published as a public key.

Afterwards, for example, assume that the n-dimensional vector \vec{c} of equation (41) is input as a ciphertext.

\vec{c}=(73964015,0,0,0) (41)

Then, the control unit 302 extracts the first element c (=73964015) of the vector \vec{c} of equation (41), and starts the decrypting process in FIG. 11. That is, in step S301 in FIG. 11, the control unit 302 inputs the following five values to the decryption unit 312.
w=5356184
−w=4
s=5
d=1143821449
c=73964015

Then, in step S302, the decryption unit 312 inputs the values c and w to the scalar multiplication unit 307. Then, in step S303, the scalar multiplication unit 307 calculates the product (c×w) of the values c and w as indicated in equation (42), and then outputs the product to the decryption unit 312.

$$\begin{matrix}c \times w = 73964015 \times 5356184 \\ = 396164873718760\end{matrix} \qquad ( 42 )$$

Then, in step S304, the decryption unit 312 inputs the value (c×w) of equation (42) and the above-mentioned value d to the first modulo operation unit 313. Then, in step S305, the first modulo operation unit 313 calculates the value [c×w]_{d} as in equation (43), and outputs this value to the decryption unit 312.

$$\begin{matrix}{[ c \times w ]}_{d} = {[ 396164873718760 ]}_{1143821449} \\ = 27214712\end{matrix} \qquad ( 43 )$$

Then, in step S306, the decryption unit 312 inputs the value [c×w]_{d} of equation (43) and the above-mentioned inverse w⁻¹ to the scalar multiplication unit 307. Then, in step S307, the scalar multiplication unit 307 calculates the value ([c×w]_{d}×w⁻¹) as in equation (44), and outputs this value to the decryption unit 312.

$$\begin{matrix}{[ c \times w ]}_{d} \times {w}^{- 1} = 27214712 \times 4 \\ = 108858848\end{matrix} \qquad ( 44 )$$

Then, in step S308, the decryption unit 312 inputs the value ([c×w]_{d}×w⁻¹) of equation (44) and the above-mentioned value s to the second modulo operation unit 314. Then, in step S309, the second modulo operation unit 314 calculates the value b as in equation (45), and outputs the value b to the decryption unit 312.

$$\begin{matrix}b = {[ c \times w ]}_{d} \times {w}^{- 1} mod s \\ = 108858848 mod 5 \\ = 3\end{matrix} \qquad ( 45 )$$

Then, the plaintext b(=3) is output from the decryption unit 312 to the control unit 302 in step S310, and output from the control unit 302 through the input/output unit 301 in step S311.

As described above, also in the second embodiment as in the first embodiment, the merit that the decryption is performed at a high-speed because the number of multiplications is small is compatible with the merit that a plaintext space is extended.

Described next is the third embodiment. FIG. 12 is a block diagram of a decryption device 400 according to the third embodiment.

The decryption device 400 in FIG. 12 includes an input/output unit 401, a control unit 402, a storage unit 403, a decryption unit 404, a first modulo operation unit 405, a second modulo operation unit 406, and a scalar multiplication unit 407. The decryption device 400 may be concretely realized by the computer 100 in FIG. 2.

The input/output unit 401 operates as an input interface for input to the decryption device 400, and also operates as an output interface for output from the decryption device 400. For example, the input/output unit 401 as an input interface may be realized by one or both of the communication interface 103 and the input device 104. The input/output unit 401 as an output interface may be realized by one or both of the communication interface 103 and the output device 105. Depending on the case, the input/output unit 401 may be realized by a data input/output interface (for example, a disk controller) between the non-volatile storage device 106 and the processor 101.

The control unit 402 controls decryption. The control unit 402 may be realized by, for example, the processor 101.

In the third embodiment, the control unit 402 specifically receives, as a ciphertext, the n-dimensional vector \vec{c} whose elements are all 0 except the first element, or the first element c of the vector \vec{c}. The control unit 402 extracts the first element c when it receives the vector \vec{c}. Then, the control unit 402 starts the decrypting process in FIG. 11 on the value c, which has been received as the ciphertext or has been extracted as described above.

The storage unit 403 is similar to the storage unit 311 in the second embodiment, and may be realized by the non-volatile storage device 106. More specifically, the storage unit 403 stores the information for use in the decryption (concretely, the following four values).
the element w coprime to the plaintext space size s in the matrix W (=dV⁻¹)
the inverse w⁻¹
the plaintext space size s
the determinant d of the public key B

In the third embodiment, the decryption device 400 may receive the above-mentioned four values through a secure encrypted communication path from another device other than the decryption device 400 (for example, from the computer 130 in FIG. 2 as a key generation device). Then, the values thus received by the decryption device 400 may be stored in the storage unit 403.

Otherwise, the decryption device 400 itself may once search for the above-mentioned element w and calculate the inverse w⁻¹. For example, the decryption device 400 may receive the secret key V (or the n values v₀, v₁, . . . , vₙ₋₁, which define the secret key V) through a secure communication path from the key generation device (for example, the computer 130 in FIG. 2). In addition, the decryption device 400 may further include modules similar to the inverse matrix calculation unit 304, the scalar-matrix multiplication unit 306, the scalar multiplication unit 307, the search unit 308, the GCD calculation unit 309, and the inverse element calculation unit 310 in FIG. 7. The decryption device 400 may calculate the matrix W, search for the element w, and calculate the inverse w⁻¹, by using these modules.

Regardless of how the decryption device 400 acquires the above-mentioned four values w, w⁻¹, s, and d, the storage unit 403 stores the four values w, w⁻¹, s, and d. That is, the storage unit 403 is similar to the storage unit 311 in FIG. 7.

Furthermore, the decryption unit 404 is similar to the decryption unit 312 in FIG. 7. In addition, the first modulo operation unit 405 is similar to the first modulo operation unit 313 in FIG. 7, and the second modulo operation unit 406 is similar to the second modulo operation unit 314 in FIG. 7. The scalar multiplication unit 407 is similar to the scalar multiplication unit 307 in FIG. 7. The decryption unit 404, the first modulo operation unit 405, the second modulo operation unit 406, and the scalar multiplication unit 407 may be realized by, for example, the processor 101 in FIG. 2.

Next, the operation of the decryption device 400 according to the third embodiment is described below with reference to FIG. 11.

Upon receipt of the n-dimensional vector \vec{c} or the first element c of the vector \vec{c} as a ciphertext, the control unit 402 starts the decrypting process in FIG. 11. In step S301, the control unit 402 reads the four values w, w⁻¹, s, and d from the storage unit 403, and inputs these four values and the value c as the ciphertext to the decryption unit 404.

Then, in step S302, the decryption unit 404 inputs the two values c and w to the scalar multiplication unit 407. In step S303, the scalar multiplication unit 407 performs a multiplication, and outputs the obtained product to the decryption unit 404.

Then, in step S304, the decryption unit 404 inputs the value (c×w) and the value d to the first modulo operation unit 405. In step S305, the first modulo operation unit 405 calculates the value [c×w]_{d} and outputs the calculation result to the decryption unit 404.

Then, in step S306, the decryption unit 404 inputs the two values [c×w]_{d} and w⁻¹ to the scalar multiplication unit 407. In step S307, the scalar multiplication unit 407 performs a multiplication, and outputs the obtained product to the decryption unit 404.

Then, in step S308, the decryption unit 404 inputs the value [c×w]_{d}×w⁻¹ and the value s to the second modulo operation unit 406. In step S309, the second modulo operation unit 406 calculates the plaintext b, and outputs the plaintext b to the decryption unit 404.

Then, the plaintext b is output from the decryption unit 404 to the control unit 402 in step S310, and is output from the control unit 402 through the input/output unit 401 in step S311.

For example, in the case where c=73964015, the plaintext b which is 3 is output also in the third embodiment as well as in the above-described numerical examples of the second embodiment.

As described above, also in the third embodiment as in the first and second embodiments, the merit that the decryption is performed at a high-speed because the number of multiplications is small is compatible with the merit that a plaintext space is extended.

The present invention is not limited to the above-mentioned first through third embodiments. Although explained above about some modifications, the above-mentioned first through third may be further modified, for example, as follows.

For example, the information processing device 300 according to the second embodiment is a key generation device and also is a decryption device. However, a key generation device different from a decryption device may perform the following processes depending on the embodiment.
the processes in steps S201 through S232
the process of transmitting the four values s, d, w, and w⁻¹, which have been stored in the storage unit in step 231, to the decryption device through a secure encrypted communication path at an appropriate time

The process of transmitting the values s, d, w, and w⁻¹ as described above may be performed, for example, immediately after the execution of step S231, or may be performed at a request from the decryption device. Furthermore, the decryption device to be used in combination with the above-mentioned key generation device may be specifically the decryption device 400 according to the third embodiment.

Furthermore, the key generation device may transmit any piece of information as listed below to the decryption device instead of transmitting both the value w and its inverse w⁻¹ to the decryption device as mentioned above. This is because, if any piece of the information listed below is received, the decryption device is able to acquire both the value w and its inverse w⁻¹ from the received information.
a tuple of the n values v₀, v₁, . . . , vₙ₋₁, which define the secret key V
the secret key V
the inverse matrix V⁻¹ of the secret key V
the matrix W (=dV⁻¹)
any one row or any one column in the matrix W
one of the value w and its inverse w⁻¹

Furthermore, in the flowcharts illustrated in FIGS. 8 through 11, the execution order of the steps may be appropriately changed as long as no inconsistency arises. Exchangeable steps may be concurrently performed.

For example, in the second embodiment, in the course of generating a key, it is checked whether or not the following three conditions hold true. More specifically, according to the flowcharts in FIGS. 8 through 10, the first condition is first checked, and then the second condition is checked.
the first condition that the inverse matrix V⁻¹ exists for the matrix V as a candidate for a secret key
the second condition that the matrix B, which is the Hermite normal form of the matrix V, is in the particular form of equation (6)
the third condition that there is an element w coprime to the plaintext space size s in the matrix W (=dV⁻¹)

However, depending on the embodiment, the second condition may be checked earlier than the first condition.

In addition, the first and second conditions may be concurrently checked.

The dimension n is given as an argument in some steps in FIGS. 8 through 10 (for example, step S204 etc.). However, depending on the implementation of a program executed by the information processing device 300, there may be a case in which the dimension n is not given as an argument explicitly (for example, a case in which a certain type of object-oriented language is used).

All examples and conditional language provided herein are intended for pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A decryption method executed by a computer, the decryption method comprising:
receiving, by the computer, an input of an n-dimensional vector \vec{c}=(c, 0, . . . ,0) whose elements other than a first element are all zero, or an input of a value c that is the first element of the vector \vec{c}, the vector \vec{c} being a ciphertext obtained
by encrypting a plaintext being an integer not less than 0 and less than s with a public key
which is associated with an n×n invertible matrix
$$V = [ \begin{matrix}{v}_{0} & {v}_{1} & {v}_{2} & … & {v}_{n - 1} \\ - {v}_{n - 1} & {v}_{0} & {v}_{1} & … & {v}_{n - 2} \\ - {v}_{n - 2} & - {v}_{n - 1} & {v}_{0} & … & {v}_{n - 3} \\ ⋮ & ⋮ & ⋮ & ⋱ & ⋮ \\ - {v}_{1} & - {v}_{2} & - {v}_{3} & … & {v}_{0}\end{matrix} ]$$
defined as a secret key of homomorphic cryptography by using n integers v₀, . . . , vₙ₋₁, and
which is a matrix B being an Hermite normal form of the matrix V, or
by performing a certain operation on a plurality of ciphertexts without decrypting the plurality of ciphertexts, each of the plurality of ciphertexts being obtained by encrypting each of a plurality of plaintexts being an integer not less than 0 and less than s with the matrix B;
acquiring, by the computer, an element w which is coprime to s and which is one of elements of a matrix W=dV⁻¹ defined by a determinant d of the matrix B and an inverse matrix V⁻¹ of the matrix V;
acquiring, by the computer, an inverse w⁻¹ of w modulo s;
calculating, by the computer, a value b=[c×w]_{d}×w⁻¹ mod s using a value [c×w]_{d} to which c×w mod d is regulated to be included in an interval [−d/2, d/2); and
outputting, from the computer, the calculated value b as a plaintext which corresponds to the input vector \vec{c} or to the input value c.

2. The decryption method according to claim 1, wherein
the acquiring the element w includes:
calculating the inverse matrix V⁻¹ from the matrix V;
calculating at least n elements of one row or of one column in the matrix W using the inverse matrix V¹;
searching the calculated elements of the matrix W for an element coprime to s; and
acquiring the element found by the searching, as the element w, and
the acquiring the inverse w⁻¹ includes calculating the inverse w⁻¹ from the found element w.

3. The decryption method according to claim 1, wherein
the acquiring the element w includes referring to a storage device and reading the element w stored in advance in the storage device, and
the acquiring the inverse w⁻¹ includes referring to the storage device and reading the inverse w⁻¹ stored in advance in the storage device.

4. The decryption method according to claim 1, wherein the calculating the value b includes a Montgomery modular multiplication.

5. The decryption method according to claim 1, wherein the calculating the value b includes:
a multiplication of the value c and the element w;
a modulo operation with modulus d;
a multiplication of the value [c×w]_{d} and the inverse w⁻¹; and
a modulo operation with modulus s.

6. The decryption method according to claim 1, wherein s is a prime number or a power of two.

7. A decryption device comprising:
a ciphertext reception unit that receives an input of an n-dimensional vector \vec{c}=(c, 0, . . . ,0) whose elements other than a first element are all zero, or an input of a value c that is the first element of the vector \vec{c}, the vector \vec{c} being a ciphertext obtained
by encrypting a plaintext being an integer not less than 0 and less than s with a public key
which is associated with an n×n invertible matrix
$$V = [ \begin{matrix}{v}_{0} & {v}_{1} & {v}_{2} & … & {v}_{n - 1} \\ - {v}_{n - 1} & {v}_{0} & {v}_{1} & … & {v}_{n - 2} \\ - {v}_{n - 2} & - {v}_{n - 1} & {v}_{0} & … & {v}_{n - 3} \\ ⋮ & ⋮ & ⋮ & ⋱ & ⋮ \\ - {v}_{1} & - {v}_{2} & - {v}_{3} & … & {v}_{0}\end{matrix} ]$$
defined as a secret key of homomorphic cryptography by using n integers v₀, . . . , vₙ₋₁, and
which is a matrix B being an Hermite normal form of the matrix V, or
by performing a certain operation on a plurality of ciphertexts without decrypting the plurality of ciphertexts, each of the plurality of ciphertexts being obtained by encrypting each of a plurality of plaintexts being an integer not less than 0 and less than s with the matrix B;
a first acquisition unit that acquires an element w which is coprime to s and which is one of elements of a matrix W=dV⁻¹ defined by a determinant d of the matrix B and an inverse matrix V¹ of the matrix V;
a second acquisition unit that acquires an inverse w⁻¹ of w modulo s;
a calculation unit that calculates a value b=[c×w]_{d}×w⁻¹ mod s using a value [c×w]_{d} to which c×w mod d is regulated to be included in an interval [−d/2, d/2); and
a plaintext output unit that outputs the value b calculated by the calculation unit as a plaintext which corresponds to the vector \vec{c} received by the ciphertext reception unit or to the value c received by the ciphertext reception unit.

8. The decryption device according to claim 7, wherein:
the first acquisition unit calculates the inverse matrix V⁻¹ from the matrix V, calculates at least n elements of one row or of one column in the matrix W using the inverse matrix V⁻¹, searches the calculated elements of the matrix W for an element coprime to s, and acquires, as the element w, the element found by searching the calculated elements of the matrix W; and
the second acquisition unit acquires the inverse w⁻¹ by calculating the inverse w⁻¹ from the element w found by the first acquisition unit.

9. The decryption device according to claim 7, wherein
the first acquisition unit acquires the element w by receiving the element w from a key generation device connected to the decryption device over a network, and
the second acquisition unit acquires the inverse w⁻¹ by receiving the inverse w⁻¹ from the key generation device.

10. The decryption device according to claim 8, further comprising a storage unit, wherein
the first acquisition unit stores the element w in the storage unit once the element w is acquired,
when the element w has been stored in the storage unit, the first acquisition unit acquires the element w by reading the element w from the storage unit,
the second acquisition unit stores the inverse w⁻¹ in the storage unit once the inverse w⁻¹ is acquired, and
when the inverse w⁻¹ has been stored in the storage unit, the second acquisition unit acquires the inverse w⁻¹ by reading the inverse w⁻¹ from the storage unit.

11. A key generation method executed by a computer, the key generation method comprising:
generating n integers v₀, . . . , vₙ₋₁ by the computer;
judging, by the computer, whether a first condition, a second condition, and a third condition hold true with respect to the generated n integers v₀, . . . , vₙ₋₁, wherein
the first condition is a condition that an inverse matrix V⁻¹ exists for an n×n matrix
$$V = [ \begin{matrix}{v}_{0} & {v}_{1} & {v}_{2} & … & {v}_{n - 1} \\ - {v}_{n - 1} & {v}_{0} & {v}_{1} & … & {v}_{n - 2} \\ - {v}_{n - 2} & - {v}_{n - 1} & {v}_{0} & … & {v}_{n - 3} \\ ⋮ & ⋮ & ⋮ & ⋱ & ⋮ \\ - {v}_{1} & - {v}_{2} & - {v}_{3} & … & {v}_{0}\end{matrix} ]$$
defined by the n integers v₀, . . . , vₙ₋₁,
the second condition is a condition that a matrix B
which is in an Hermite normal form,
whose (1, j)-th element is 0 for all j where 1<j≦n,
whose (i,j)-th element is 0 for all i and j where 1<i≦n, 1<j≦n, and i≠j, and
whose (i, i)-th element is 1 for all i where 1<i<n is derivable from the matrix V, and
the third condition is a condition that an element coprime to a predetermined positive integer s exists in n×n elements of a matrix W=dV⁻¹ defined by a determinant d of the matrix B and the inverse matrix V⁻¹ of the matrix V;
repeating the generating of the n integers v₀, . . . , vₙ₋₁ by the computer until the n integers v₀, . . . , vₙ₋₁ which let the first condition, the second condition, and the third condition hold true are obtained;
outputting, from the computer, the matrix B as a public key for homomorphic cryptography whose plaintext space is a set of integers which are not less than 0 and less than s, when the n integers v₀, . . . , vₙ₋₁ which let the first condition, the second condition, and the third condition hold true are obtained.

12. The key generation method according to claim 11, wherein
as information to be used in obtaining a plaintext that is an integer not less than 0 and less than s by decrypting a ciphertext that is an n-dimensional vector \vec{c}=(c, 0, . . . , 0) whose elements other than a first element are all zero, the computer transmits to a decryption device at least one of
a tuple of the n integers v₀, . . . , vₙ₋₁,
the matrix V,
the inverse matrix V⁻¹,
the matrix W,
an element w coprime to the predetermined positive integer s in the n×n elements of the matrix W, and an inverse w⁻¹ of the element w modulo s.
